(19) United States
(12) Patent Application Publication
(10) Pub. No.: US 2023/0311950 A1
(43) Pub. Date: Oct. 5, 2023

(54) AUTOMATED DRIVING CONTROL DEVICE AND STORAGE MEDIUM STORING AUTOMATED DRIVING CONTROL PROGRAM

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 18/330,334

(22) Filed: Jun. 6, 2023

Related U.S. Application Data
(63) Continuation of application No. PCT/JP2021/047484, filed on Dec. 22, 2021.

(30) Foreign Application Priority Data
Jan. 27, 2021 (JP) 2021-011264
Sep. 29, 2021 (JP) 2021-159412

(51) Int. Cl. B60W 50/14; B60W 60/00

(52) U.S. Cl. CPC B60W 60/0051; B60W 50/14; B60W 2520/10; B60W 2540/223; B60W 2552/05; B60W 2552/10; B60W 2554/4041; B60W 2554/406

(57) ABSTRACT

By an automated driving control device or a computer-readable non-transitory storage medium storing an automated driving control program capable of performing eyes-off automated driving without periphery monitoring obligation by a driver, a traffic congestion state is recognized, a start of the eyes-off automated driving is permitted or is not permitted.

### CROSS REFERENCE TO RELATED APPLICATIONS

The present application is a continuation application of International Patent Application No. PCT/JP2021/047484 filed on Dec. 22, 2021, which designated the U.S. and claims the benefit of priority from Japanese Patent Application No. 2021-011264 filed on Jan. 27, 2021 and the benefit of priority from Japanese Patent Application No. 2021-159412 filed on Sep. 29, 2021. The entire disclosures of all of the above applications are incorporated herein by reference.

### TECHNICAL FIELD

The present disclosure relates to an automated driving control device and a computer readable non-transitory storage medium storing an automated driving control program that perform automated driving without obligation to monitor a periphery, and a presentation control device and a computer readable non-transitory storage medium storing a presentation control program that controls presentation of information about the automated driving.

### BACKGROUND

In a comparative example, an automated driving system determines a situation at a periphery of a vehicle based on data acquired by a sensor, an equipment, and the like, and performs automated driving that permits a driver to perform tasks such operating a smartphone, watching TV, and the like.

### SUMMARY

By an automated driving control device or a computer-readable non-transitory storage medium storing an automated driving control program capable of performing eyes-off automated driving without periphery monitoring obligation by a driver, a traffic congestion state is recognized, a start of the eyes-off automated driving is permitted or is not permitted.

### BRIEF DESCRIPTION OF DRAWINGS

FIG. 1 is a diagram illustrating a whole image of an in-vehicle network including an automated driving system according to a first embodiment of the present disclosure.

FIG. 2 is a flowchart showing details of a traffic congestion recognition process executed by a traffic congestion recognition unit.

FIG. 3 is a diagram showing one example of a first traffic congestion state recognized by the traffic congestion recognition unit.

FIG. 4 is a diagram showing one example of a second traffic congestion state recognized by the traffic congestion recognition unit.

FIG. 5 is a diagram showing another example of the second traffic congestion state recognized by the traffic congestion recognition unit.

FIG. 6 is a diagram showing one example of a third traffic congestion state recognized by the traffic congestion recognition unit.

FIG. 7 is a flowchart showing details of a re-traffic congestion count process executed by a traffic congestion recognition unit.

FIG. 8 is a flowchart showing details of an automated driving permission process executed by a permission controller.

FIG. 9 is a flowchart showing details of a traffic congestion solving determination process executed by the permission controller.

FIG. 10 is a flowchart showing details of a state control process for eyes-off automated driving performed by the permission controller.

FIG. 11 is a time chart showing one example of a state change of automated driving at a traffic congestion Level 3 in a traffic congestion scene.

FIG. 12 is a time chart showing another example of the state change of the automated driving at the traffic congestion Level 3 in the traffic congestion scene.

FIG. 13 is a diagram showing one example of a fourth traffic congestion state recognized by the traffic congestion recognition unit according to a second embodiment.

FIG. 14 is a diagram showing one example of a fifth traffic congestion state recognized by the traffic congestion recognition unit.

FIG. 15 is a diagram showing one example of a sixth traffic congestion state recognized by the traffic congestion recognition unit.

FIG. 16 is a flowchart showing details of the traffic congestion recognition process executed by the traffic congestion recognition unit.

FIG. 17 is a flowchart showing details of the automated driving permission process executed by the permission controller.

FIG. 18 is a flowchart showing details of the state control process for the eyes-off automated driving performed by the permission controller.

FIG. 19 is a flowchart showing a driving switch request process executed by an HCU.

FIG. 20 is a flowchart showing details of the automated driving permission process according to a third embodiment.

FIG. 21 is a flowchart showing details of the automated driving permission process according to a sixth modification.

### DETAILED DESCRIPTION

As in the comparative example, the automated driving without the periphery monitoring obligation by the driver is permitted only under certain conditions such as traffic congestion, for example. Therefore, in a case such as when the situation at the periphery of the vehicle changes immediately after the start of automated driving, the started automated driving may quickly end. As a result, the convenience of automated driving may be impaired.

One example of the present disclosure provides an automated driving control device, a computer readable non-transitory storage medium storing an automated driving control program, a presentation control device and a computer readable non-transitory storage medium storing a presentation control program capable of ensuring a convenience of automated driving.

According to one example embodiment, an automated driving control device is capable of performing eyes-off automated driving without periphery monitoring obligation by a driver. The device includes: a different vehicle grasping unit configured to grasp at least existence of a front vehicle in a subject vehicle lane in which a subject vehicle is positioned and existence of a side vehicle that is adjacent to the subject vehicle and is positioned in an adjacent lane adjacent to the subject vehicle lane; a traffic congestion recognition unit configured to recognize a first traffic congestion state in which a vehicle speed of the subject vehicle is equal to or less than a predetermined speed and all of the front vehicle in the subject vehicle lane and the side vehicle in the adjacent lane exist and a second traffic congestion state in which the vehicle speed of the subject vehicle is equal to or less than the predetermined speed, the front vehicle exists in the subject vehicle lane, and the side vehicle does not exist in the adjacent lane; a permission controller that is configured to permit a start of the eyes-off automated driving in the first traffic congestion state and is configured not to permit the start of the eyes-off automated driving in the second traffic congestion state. The permission controller permits continuation of the eyes-off automated driving when a periphery of the subject vehicle transitions to the second traffic congestion state after the eyes-off automated driving starts in the first traffic congestion state.

Further, according to another example embodiment, a computer-readable non-transitory storage medium stores an automated driving control program that is capable of performing eyes-off automated driving without periphery monitoring obligation by a driver and comprises instructions configured to, when executed by at least one processor, cause the processor: to grasp at least existence of a front vehicle in a subject vehicle lane in which a subject vehicle is positioned and existence of a side vehicle that is adjacent to the subject vehicle and is positioned in an adjacent lane adjacent to the subject vehicle lane; to recognize a first traffic congestion state in which a vehicle speed of the subject vehicle is equal to or less than a predetermined speed and all of the front vehicle in the subject vehicle lane and the side vehicle in the adjacent lane exist and a second traffic congestion state in which the vehicle speed of the subject vehicle is equal to or less than the predetermined speed, the front vehicle exists in the subject vehicle lane, and the side vehicle does not exist in the adjacent lane; to permit a start of the eyes-off automated driving in a case of the first traffic congestion state; not to permit a start of the eyes-off automated driving in a case of the second traffic congestion state; and to permit continuation of the eyes-off automated driving when a periphery of the subject vehicle transitions to the second traffic congestion state after the eyes-off automated driving starts in the first traffic congestion state.

In these embodiments, the permission state of the eyes-off automated driving continues even when transition occurs from the first traffic congestion state transitions to the second traffic congestion state after the eyes-off automated driving starts. In this way, when the continuation condition of the eyes-off automated driving is relaxed more than the start condition, it is possible to avoid a situation in which the eyes-off automated driving ends prematurely since started. As described above, it is possible to easily perform the continuous eyes-off automated driving. Therefore, it is possible to ensure the convenience of automated driving.

According to another example embodiment, an automated driving control device is capable of performing eyes-off automated driving without periphery monitoring obligation by a driver. The device includes: a lane determination unit configured to determine whether a subject vehicle is traveling in a passing lane; a traffic congestion recognition unit configured to recognize a traffic congestion state at a periphery of the subject vehicle; and a permission controller that is configured to permit a start of the eyes-off automated driving based on a recognition of the traffic congestion state when the subject vehicle travels in a traveling lane different from the passing lane and is configured not to permit the start of the eyes-off automated driving when the subject vehicle travels in the passing lane.

Further, according to another example embodiment, a computer-readable non-transitory storage medium stores an automated driving control program that is capable of performing eyes-off automated driving without periphery monitoring obligation by a driver and comprises instructions configured to, when executed by at least one processor, cause the processor: to determine whether a subject vehicle is traveling in a passing lane; to recognize a traffic congestion state at a periphery of the subject vehicle; to permit a start of the eyes-off automated driving based on recognition of the traffic congestion state when the subject vehicle travels in a traveling lane different from a passing lane; and not to permit the start of the eyes-off automated driving based on recognition of the traffic congestion state when the subject vehicle travels in the passing lane.

Further, according to another example embodiment, an automated driving control device is capable of performing eyes-off automated driving without periphery monitoring obligation by a driver. The device includes: a lane determination unit configured to determine whether a subject vehicle is traveling in a passing lane; a traffic congestion recognition unit configured to recognize a traffic congestion state at a periphery of the subject vehicle; and a permission controller configured to set a first permission condition to be stricter than a second permission condition, wherein the first permission condition is a condition that permits a start of the eyes-off automated driving based on the traffic congestion state when the subject vehicle travels in the passing lane, and the second permission condition is a condition that permits the eyes-off automated driving based on the traffic congestion state when the subject vehicle travels in a traveling lane different from the passing lane. Further, according to another example embodiment, a computer-readable non-transitory storage medium stores an automated driving control program that is capable of performing eyes-off automated driving without periphery monitoring obligation by a driver and comprises instructions configured to, when executed by at least one processor, cause the processor to: determine whether a subject vehicle is traveling in a passing lane; recognize a traffic congestion state at a periphery of the subject vehicle; and set a first permission condition to be stricter than a second permission condition, wherein the first permission condition is a condition that permits a start of the eyes-off automated driving based on the traffic congestion state when the subject vehicle travels in the passing lane, and the second permission condition is a condition that permits the eyes-off automated driving based on the traffic congestion state when the subject vehicle travels in a traveling lane different from the passing lane.

In these embodiments, when the subject vehicle travels in the passing lane, the start of the eyes-off automated driving based on the recognition of the traffic congestion state is prevented. In general, the traffic congestion in the passing lane tends to be solved earlier than in the traveling lane. Therefore, according to the prevention of the start of the eyes-off automated driving in the passing lane, it is possible to avoid quick end of the once-started eyes-off automated driving. As described above, it is possible to easily perform the continuous eyes-off automated driving. Therefore, it is possible to ensure the convenience of automated driving. Further, according to another example embodiment, an automated driving control device is capable of performing eyes-off automated driving without periphery monitoring obligation by a driver. The device includes: a lane determination unit configured to determine whether a subject vehicle is traveling in a passing lane; a traffic congestion recognition unit configured to recognize a traffic congestion state at a periphery of the subject vehicle; and a permission controller configured to permit a start of the eyes-off automated driving based on recognition of the traffic congestion state, and start preparation for ending the eyes-off automated driving when a vehicle speed of the subject vehicle exceeds a predetermined speed after a start of the eyes-off automated driving. The traffic congestion recognition unit recognizes that the traffic congestion state has occurred again when the predetermined speed becomes equal to or less than the predetermined speed again after the vehicle speed of the subject vehicle exceeds the predetermined speed. The permission controller stops the preparation for ending the eyes-off automated driving based on recognition that the traffic congestion state has occurred again, when the subject vehicle travels in a traveling lane different from the passing lane. The permission controller continues the preparation for ending the eyes-off automated driving even when having recognized that the traffic congestion state has occurred again, in a case where the subject vehicle travels in the passing lane.

Further, according to another example embodiment, a computer-readable non-transitory storage medium stores an automated driving control program that is capable of performing eyes-off automated driving without periphery monitoring obligation by a driver and comprises instructions configured to, when executed by at least one processor, cause the processor to: determine whether a subject vehicle is traveling in a passing lane; recognize a traffic congestion state at a periphery of the subject vehicle; and permit a start of the eyes-off automated driving based on recognition of the traffic congestion state; start preparation for ending the eyes-off automated driving when a vehicle speed of the subject vehicle exceeds a predetermined speed after a start of the eyes-off automated driving; recognize that the traffic congestion state has occurred again when the predetermined speed becomes equal to or less than the predetermined speed again after the vehicle speed of the subject vehicle exceeds the predetermined speed; stop the preparation for ending the eyes-off automated driving based on recognition that the traffic congestion state has occurred again, when the subject vehicle travels in a traveling lane different from the passing lane; and continue the preparation for ending the eyes-off automated driving even when having recognized that the traffic congestion state has occurred again, in a case where the subject vehicle travels in the passing lane.

In these embodiments, in the case where the subject vehicle travels in the passing lane, even when the re-traffic congestion state is recognized, the preparation for ending the eyes-off automated driving continues. In general, the traffic congestion in the passing lane is likely to be solved earlier than in the traveling lane. Therefore, it is possible to prevent unnecessary changes in the control state by continuing the preparation for ending the eyes-off automated driving even when the re-traffic congestion state has occurred. As the result, it is possible to smoothly end the eyes-off automated driving. Therefore, it is possible to ensure the convenience of automated driving.

Further, according to another example embodiment, an automated driving control device is capable of, by using information of an autonomous sensor, performing eyes-off automated driving without periphery monitoring obligation by a driver. The device includes: a traffic congestion information acquisition unit configured to acquire traffic congestion information of a road on which a subject vehicle is scheduled to travel; a traffic congestion recognition unit configured to recognize whether a periphery of the subject vehicle is in a traffic congestion state by using the information of the autonomous sensor; and a permission controller configured to permit a start of the eyes-off automated driving when the traffic congestion recognition unit has recognized that the periphery of the subject vehicle is in the traffic congestion state. The permission controller suspends an end of the eyes-off automated driving when determining that the traffic congestion state continues based on the traffic congestion information, in a case of having recognized that a traffic congestion is solved after a start of the eyes-off automated driving.

Further, according to another example embodiment, a computer-readable non-transitory storage medium stores an automated driving control program that is capable of, by using information of an autonomous sensor, performing eyes-off automated driving without periphery monitoring obligation by a driver and comprises instructions configured to, when executed by at least one processor, cause the processor to: recognize whether a periphery of a subject vehicle is in a traffic congestion state by using the information of the autonomous sensor; permit a start of the eyes-off automated driving when having recognized that the periphery of the subject vehicle is in the traffic congestion state; acquire traffic congestion information of a road on which a subject vehicle is scheduled to travel; and suspend an end of the eyes-off automated driving when determining that a traffic congestion continues based on the traffic congestion information, in a case of having recognized that the traffic congestion is solved after a start of the eyes-off automated driving.

In these embodiments, in the case where, after the start of the eyes-off automated driving, it is recognized that traffic congestion state has been solved based on the autonomous sensor information, the end of the eyes-off automated driving is suspended when the traffic congestion is determined to continue based on the traffic congestion information of the road on which the vehicle is scheduled to travel. In such a manner, by preventing the condition for canceling the eyes-off automated driving from being satisfied, it is possible to avoid a situation in which the eyes-off automated driving ends prematurely once started. Accordingly, it is possible to easily perform the continuous eyes-off automated driving. Therefore, it is possible to ensure the convenience of automated driving.

Further, according to another example embodiment, an automated driving control device is capable of, by using information of an autonomous sensor, performing eyes-off automated driving without periphery monitoring obligation by a driver. The device includes: a traffic congestion information acquisition unit configured to acquire input information of the driver, the input information indicating whether a road on which a subject vehicle is scheduled to travel is congested; a traffic congestion recognition unit configured to recognize whether a periphery of the subject vehicle is in a traffic congestion state by using the information of the autonomous sensor; and a permission controller configured to permit a start of the eyes-off automated driving when the traffic congestion recognition unit has recognized that the periphery of the subject vehicle is in the traffic congestion state. The permission controller suspends an end of the eyes-off automated driving when the traffic congestion information acquisition unit has acquired the input information indicating continuation of a traffic congestion, in a case of having recognized that the traffic congestion is solved after a start of the eyes-off automated driving.

Further, according to another example embodiment, a computer-readable non-transitory storage medium stores an automated driving control program that is capable of, by using information of an autonomous sensor, performing eyes-off automated driving without periphery monitoring obligation by a driver and comprises instructions configured to, when executed by at least one processor, cause the processor to: recognize whether a periphery of a subject vehicle is in a traffic congestion state by using the information of the autonomous sensor; permit a start of the eyes-off automated driving when having recognized that the periphery of the subject vehicle is in the traffic congestion state; acquire input information of the driver, the input information indicating whether a road on which a subject vehicle is scheduled to travel is congested; and suspend an end of the eyes-off automated driving when the traffic congestion information acquisition unit has acquired the input information indicating continuation of a traffic congestion, in a case of having recognized that the traffic congestion is solved after a start of the eyes-off automated driving.

In these embodiments, in the case where, after the start of the eyes-off automated driving, it is recognized that traffic congestion state has been solved based on the autonomous sensor information, the end of the eyes-off automated driving is suspended when the traffic congestion is determined to continue based on input information based on driver determination. In such a manner, by preventing the condition for canceling the eyes-off automated driving from being satisfied, it is possible to avoid a situation in which the eyes-off automated driving ends prematurely once started. Accordingly, it is possible to easily perform the continuous eyes-off automated driving. Therefore, it is possible to ensure the convenience of automated driving.

Further, according to another example embodiment, a presentation control device controls presentation of information related to eyes-off automated driving without periphery monitoring obligation by a driver. The device includes: a control grasping unit configured to grasp an end schedule of the eyes-off automated driving only when a subject vehicle travels during a traffic congestion; and a notification controller configured to provide a switch request notification for requesting driving switch to a driver before the eyes-off automated driving ends. When the subject vehicle is traveling in a passing lane with the eyes-off automated driving, the notification controller sets a start timing of the switch request notification to be earlier than that when the subject vehicle travels with the eyes-off automated driving in a traveling lane different from the passing lane.

Further, according to another example embodiment, a computer-readable non-transitory storage medium stores a presentation control program that controls presentation of information related to eyes-off automated driving without periphery monitoring obligation by a driver and comprises instructions configured to, when executed by at least one processor, cause the processor to: grasp an end schedule of the eyes-off automated driving only when a subject vehicle travels during a traffic congestion; provide a switch request notification for requesting driving switch to a driver before the eyes-off automated driving ends; and when the subject vehicle is traveling in a passing lane with the eyes-off automated driving, set a start timing of the switch request notification to be earlier than that when the subject vehicle travels with the eyes-off automated driving in a traveling lane different from the passing lane.

In these embodiments, when the subject vehicle is traveling in the passing lane, the start timing of the switch request notification for requesting the driver to perform driving switch is set to be earlier than the start timing in the case of traveling in the traveling lane. In general, the traffic congestion in the passing lane is likely to be solved earlier than in the traveling lane. Therefore, by setting the start timing of the switch request notification in the passing lane to the earlier timing, it is possible to smoothly execute the driving switch process from the eyes-off automated driving to the driver. Therefore, it is possible to ensure the convenience of automated driving.

The following will describe embodiments of the present disclosure with reference to accompanying drawings. Incidentally, the same reference numerals are assigned to the corresponding components in each embodiment, and thus, duplicate descriptions may be omitted. In each of the embodiments, when only a part of the configuration is described, the remaining parts of the configuration may adopt corresponding parts of other embodiments. Further, not only the combinations of the configurations explicitly shown in the description of the respective embodiments, but also the configurations of the plurality of embodiments can be partially combined even when they are not explicitly shown as long as there is no difficulty in the combination in particular.

### First Embodiment

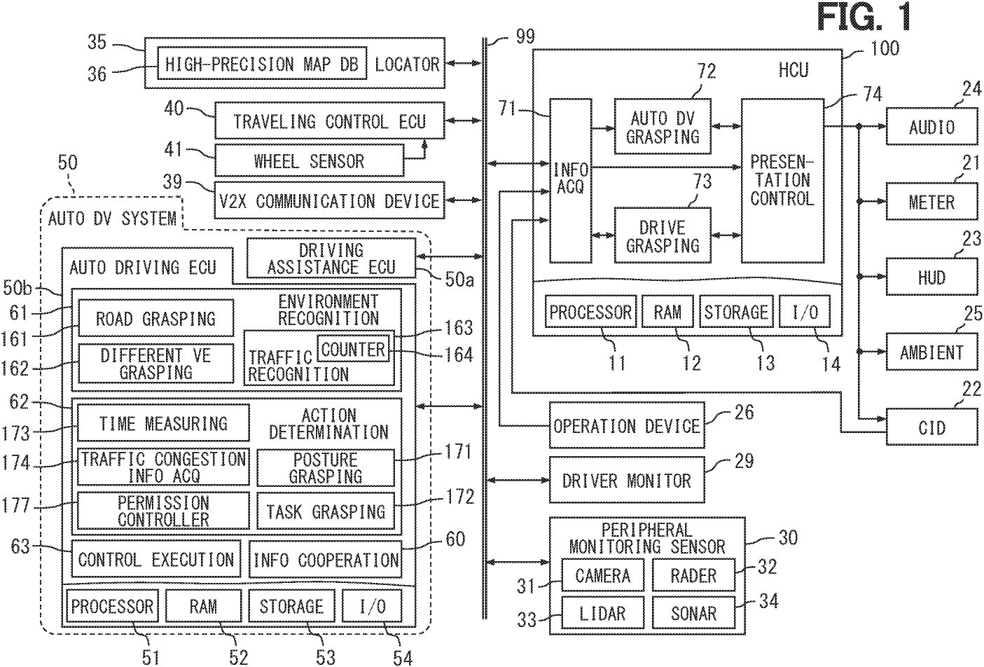

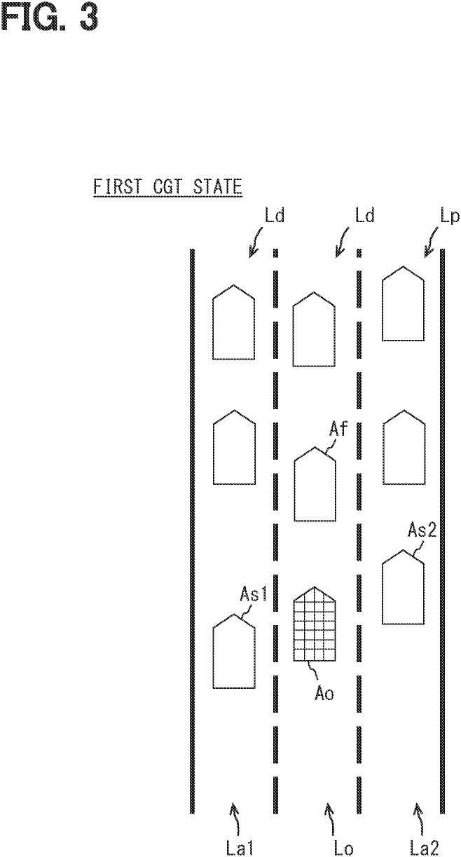

A function of an automated driving control device according to a first embodiment of the present disclosure is implemented by an automated driving ECU (Electronic Control Unit) 50b shown in FIG. 1. The automated driving ECU 50b is mounted on a vehicle (hereinafter referred to as subject vehicle Ao, see FIG. 3) together with a driving assistance ECU 50a, and constitutes an automated driving system 50 together with the driving assistance ECU 50a. In the drawings, the terms of “automated driving” may be also referred to as “AUTO DV”, and the term of “vehicle” may be also referred to as “VE”. By mounting the automated driving system 50, the subject vehicle Ao becomes an automated driving vehicle provided with an automated driving function.

The driving assistance ECU 50a is an in-vehicle ECU that implements a driving assistance function that assists driving operation of a driver in the automated driving system 50. The driving assistance ECU 50a enables advanced driving assistance of about Level 2 or partial automated travel control at an automated driving level defined by the Society of Automotive Engineers. The automated driving performed by the driving assistance ECU 50a is an automated driving with periphery monitoring obligation that requires the driver to visually monitor the periphery of the subject vehicle.

The automated driving ECU 50b is an in-vehicle ECU that implements an automated driving function capable of acting for the driving operation of the driver in the automated driving system 50. The automated driving ECU 50b enables the automated driving at Level 3 or higher in which the system is the main control unit, that is, eyes-off automated driving that does not require the driver to visually monitor the periphery of the vehicle. The automated driving ECU 50b may be capable of implementing an automated driving function of Level 4 or higher.

In the automated driving system 50, the control state of the automated driving function is switched among multiple functions including at least the automated driving control with the obligation to monitor the periphery by the driving assistance ECU 50a and the automated driving control without the obligation to monitor the periphery by the automated driving ECU 50b. In the following description, the automated driving control of level 2 or lower by the driving assistance ECU 50a may be described as “driving assistance control”, and the automated driving control of Level 3 or higher by the automated driving ECU 50b may be described as “autonomous traveling control”.

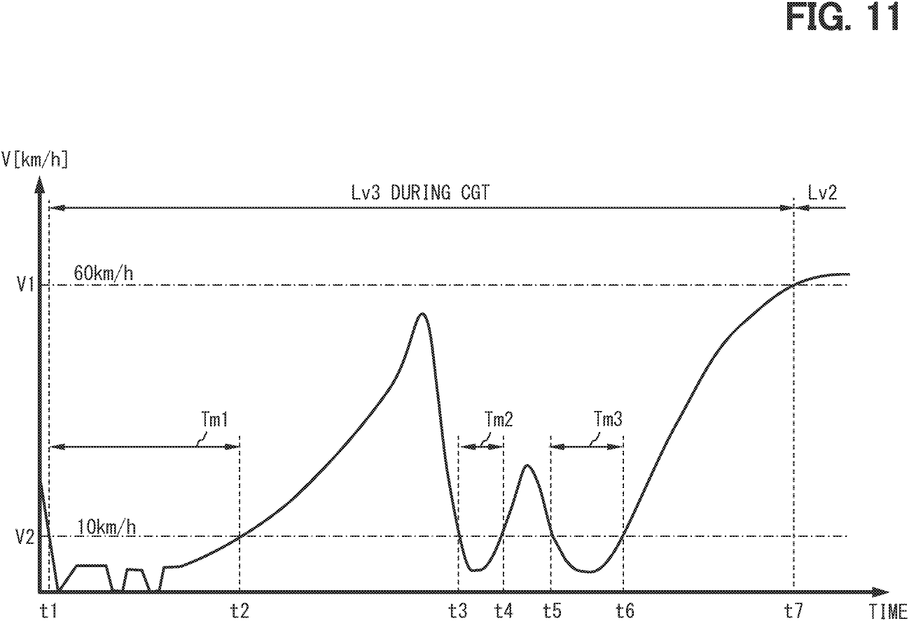

As shown in traffic congestion periods Tm1 to Tm3 of FIG. 11, during an automated traveling period in which the subject vehicle Ao automatically travels under the autonomous traveling control by the automated driving ECU 50b, the driver is permitted to perform a specific action (hereinafter referred to as second task) other than a predetermined driving. In the drawings, the terms of “traffic congestion” may be also referred to as “CGT”. The second task is legally permitted to the driver until the automated driving system 50 issues a request to perform a driving operation, that is, a request to switch the driving. For example, watching entertainment content such as video content, operating a device such as a smartphone, eating a meal, and the like are assumed as second tasks.

The automated driving ECU 50b and the driving assistance ECU 50a are communicably connected to a communication bus 99 of an in-vehicle network mounted on the subject vehicle Ao. Each of the automated driving ECU 50b and the driving assistance ECU 50a is one of multiple nodes provided in the in-vehicle network. The communication bus 99 is connected to a driver monitor 29, a periphery monitoring sensor 30, a locator 35, a V2X communication device 39, a travel control ECU 40, a HCU (Human Machine Interface Control Unit) 100, and the like. These nodes connected to the communication bus 99 of the in-vehicle network can communicate with each other. It should be noted that specific nodes among the multiple devices and the multiple ECUs may be directly electrically connected with one another and can communicate with one other without using the communication bus 99.

The driver monitor 29 includes a near-infrared light source, a near-infrared camera, and a control unit that controls them. The driver monitor 29 is installed, for example, on the upper surface of a steering column portion or the upper surface of an instrument panel in a posture in which the near-infrared camera faces a headrest portion of a driver’s seat. The near-infrared camera may be integrated with a meter display 21 or a center information display (hereinafter, CID) 22 to be described later so as to be placed in either screen.

The driver monitor 29 photographs, with the near-infrared camera, the head of a driver that is irradiated with near-infrared light by the near-infrared light source. An image captured by the near-infrared camera is subjected to image analysis by the control unit. The control unit extracts information such as the driver’s eye point position and line-of-sight direction from the captured image. The driver monitor 29 provides driver status information extracted by the control unit to the HCU 100, the automated driving ECU 50b, and the like.

The periphery monitoring sensor 30 is an autonomous sensor that monitors a peripheral environment of the subject vehicle Ao. The periphery monitoring sensor 30 can detect a moving object and a stationary object specified in advance from a detection range at the periphery of the subject vehicle. The periphery monitoring sensor 30 can detect at least a front vehicle Af (see FIG. 3), a rear vehicle and side vehicles As1 and As2 (see FIG. 3), and the like traveling at the periphery of the subject vehicle Ao. The side vehicle may mean a vehicle positioned at the left or the right of the subject vehicle Ao. The periphery monitoring sensor 30 provides detection information of objects at the periphery of the subject vehicle to the driving assistance ECU 50a, the automated driving ECU 50b, and the like.

The periphery monitoring sensor 30 includes, for example, one or more of camera unit 31, a millimeter wave radar 32, a lidar 33 and a sonar 34. The camera unit 31 may have a configuration including a monocular camera or may have a configuration including a compound-eye camera. The camera unit 31 is mounted on the subject vehicle Ao so as to be able to image a range in front of the subject vehicle Ao. The camera unit 31 capable of imaging, in other words, capturing the side range and the rear range of the own vehicle Ao may be mounted on the subject vehicle Ao. The camera unit 31 outputs at least one of imaging data obtained by imaging the periphery of the subject vehicle and an analysis result of the imaging data as detection information.

The millimeter-wave radar 32 emits a millimeter wave or a quasi-millimeter wave toward the periphery of the subject vehicle. The millimeter-wave radar 32 outputs detected information generated by processing to receive a reflected wave reflected by the moving object, the stationary object, or the like. The lidar 33 emits a laser beam toward the periphery of the subject vehicle. The lidar 33 outputs the detection information generated by a process of receiving laser light reflected by a moving object, a stationary object, or the like existing within the irradiation range. The sonar 34 emits ultrasonic waves to the periphery of the subject vehicle. The sonar 34 outputs detection information generated by a process of receiving ultrasonic waves reflected by moving and stationary objects existing near the subject vehicle.

The locator 35 includes a GNSS (global navigation satellite systems) receiver, an inertial sensor, and the like. The locator 35 combines positioning signal received by the GNSS receiver, measurement result of the inertial sensor, vehicle speed information output to the communication bus 99, and the like, and successively specifies a position and a travelling direction of the subject vehicle Ao. The locator 35 sequentially outputs, as locator information, the position information and the direction information of the subject vehicle Ao based on a positioning result to the communication bus 99.

The locator 35 further has a high-precision map database (hereinafter referred to as high-precision map DB) 36. The high-precision map DB 36 mainly includes a large-capacity storage medium storing a large number of pieces of three-dimensional map data and two-dimensional map data. The three-dimensional map data is so-called HD (High Definition) map data, and includes road information necessary for the automated driving control. The three-dimensional map data includes information necessary for advanced driving assistance and automated driving, such as three-dimensional shape information on a road and detailed information on each lane. The locator 35 reads map data of the periphery of the current position from the high-precision map DB 36, and provides it to the driving assistance ECU 50a, the automated driving ECU 50b, and the like with locator information.

A vehicle to everything (V2X) communication device 39 is a vehicle exterior communication unit mounted on the subject vehicle Ao. The V2X communication device 39 transmits and receives information to and from a roadside device installed on the side of the road by wireless communication. In one example, the V2X communication device 39 receives traffic congestion information of the periphery of the current position of the subject vehicle Ao and in the traveling direction from a roadside device. The traffic congestion information is VICS (registered trademark) information or the like. The V2X communication device 39 provides the received traffic congestion information to the automated driving ECU 50b and the like.

The traveling control ECU 40 is an electronic control device that mainly includes a microcontroller. The travel control ECU 40 has at least functions of a brake control ECU, a drive control ECU, and a steering control ECU. The travel control ECU 40 continuously executes a braking force control of each wheel, an output control of an in-vehicle power source, and a steering angle control on the basis of any one of an operation command based on a driving operation by the driver, a control command by the driving assistance ECU 50a, and a control command by the automated driving ECU 50b. In addition, the travel control ECU 40 generates vehicle speed information indicating the current traveling speed of the subject vehicle Ao on the basis of a detection signal of a wheel speed sensor 41 provided in the hub portion of each wheel, and sequentially outputs the generated vehicle speed information to the communication bus 99.

The HCU 100 comprises an HMI (Human Machine Interface) system together with multiple display devices, an audio device 24, an ambient light 25, an operation device 26, and the like. The HMI system has an input interface function that accepts an operation made by an occupant such as a driver of the subject vehicle Ao, and an output interface function that presents information to the driver.

The display device presents information through image display or the like through the driver’s vision. The display devices include a meter display 21, a CID 22, a head-up display (hereinafter referred to as HUD) 23, and the like. The CID 22 has a touch panel function and detects a touch operation on the display screen by the driver or the like. The audio device 24 includes multiple speakers installed in the vehicle interior in an arrangement surrounding the driver’s seat. A notification sound, a voice message, or the like is reproduced in the passenger compartment by a speaker. The ambient light 25 is provided on an instrument panel, a steering wheel, and the like. The ambient light 25 presents information using the driver’s peripheral vision by ambient display that changes the color of emitted light.

The operation device 26 is an input portion that receives an operation of user, such as a driver or the like. The user operation or the like related, for example, to the operation and stop of the automated driving function is input to the operation device 26. The operation device 26 includes a steering switch provided on a spoke portion of a steering wheel, an operation lever provided on a steering column portion, a voice input device that recognizes utterance content of the driver, and the like.

The HCU 100 functions as a presentation control device that comprehensively controls the presentation of information related to the automated driving to the driver. The HCU 100 cooperates with the automated driving ECU 50b and allows the driver to perform the second task. The HCU 100 can request the driver to switch driving based on the request to perform the driving operation by the automated driving ECU 50b, and can reproduce video content or the like related to the second task without interfering with the request for driving change.

The HCU 100 mainly includes a control circuit including a processor 11, a RAM 12, a storage 13, an I/O interface 14, a bus that connects them, and the like. The processor 11 is a hardware combined with the RAM 12, and executes arithmetic processing. The processor 11 includes at least one arithmetic core, such as a central processing unit (CPU) or a graphics processing unit (GPU). The processor 11 may further include a field-programmable gate array (FPGA), a neural network processing unit (NPU), an IP core having other dedicated functions, and the like. The RAM 12 may include a video RAM for generating video data. The processor 11 accesses the RAM 12 to execute various processes for a presentation control process. The storage 13 includes a non-volatile storage medium. The storage unit 13 stores various programs (a presentation control program, etc.) to be executed by the processor 11.

The HCU 100 has multiple functional units for integrally controlling presentation information to the driver by executing the presentation control program stored in the storage 13 by the processor 11. Specifically, the HCU 100 includes functional units such as an information acquisition unit 71, an automated driving grasping unit 72, a driver grasping unit 73, and a presentation controller 74.

The information acquisition unit 71 acquires vehicle information indicating a state of the subject vehicle Ao from the communication bus 99. The vehicle information includes, for example, the vehicle speed information, control status information (described later) indicating the state of the automated driving function, and the like. The information acquisition unit 71 acquires an execution request for notification related to the automated driving function from the automated driving ECU 50b through the communication bus 99. The information acquisition unit 71 acquires operation information indicating the content of the user operation from the CID 22, the operation device 26, or the like. The information acquisition unit 71 acquires driver information indicating the state of the driver. The driver information includes driver status information output by the driver monitor 29, reclining information indicating a reclining state of a backrest of a driver seat, steering grip information indicating a gripping state of the steering wheel, and the like.

The automated driving grasping unit 72 grasps an execution state of automated driving by the automated driving system 50 based on the control status information acquired by the information acquisition unit 71. Specifically, the automated driving grasping unit 72 grasps whether the automated driving function is in an operating state in the automated driving system 50. When the automated driving function is in an operating state, the automated driving grasping unit 72 further grasps information indicating whether a driver’s steering operation is required, whether a driver’s periphery monitoring is required, whether a periphery monitoring unnecessary state is scheduled to end, and the like.

Based on the driver information acquired by the information acquisition unit 71, the driver grasping unit 73 grasps the content of the second task performed by the driver. For example, the driver grasping unit 73 grasps information such as operating a smartphone, watching a screen of the CID 22, operating a touch panel of the CID 22, and the like.

The driver grasping unit 73 determines whether a driving posture of the driver is appropriate based on the driver information acquired by the information acquisition unit 71. In one example, when the driver grasping unit 73 can confirm that the driver is monitoring the periphery, that the reclining of the driver seat is equal to or less than a predetermined value, and that the steering wheel is gripped, the grasping unit 73 determines that the driving posture is appropriate.

The driver grasping unit 73 grasps the content of the user operation input to the touch panel of the CID 22 or the operation device 26 in response to the inquiry to the driver by the presentation controller 74. In one example, an inquiry is made to the driver as to whether the road on which the subject vehicle Ao is scheduled to travel is congested. The driver grasping unit 73 acquires a driver determination result indicating whether the road on which the vehicle is scheduled to travel is in a congestion state, based on the user operation.

The driver grasping unit 73 provides, to the automated driving ECU 50b, task information indicating the content of the second task being executed, driver posture information indicating whether the driver driving posture is appropriate, input information indicating the driver determination result, and the like.

The presentation controller 74 integrally controls provision of information to the driver using each display device and the audio device 24. The presentation controller 74 performs the above-described inquiry to the driver, reproduction of video content and the like, notification of the driver switch request, and the like, in accordance with an automated driving execution state grasped by the automated driving grasping unit 72, based on the notification execution request acquired by the information acquisition unit 71. The presentation controller 74 permits the reproduction of video content related to the second task only when the automated driving function is in the operating state and the driving state is in the eyes-off automated driving state that does not require the driver to monitor the periphery. When the automated driving grasping unit 72 grasps that the eyes-off automated driving is scheduled to end, the presentation controller 74 ends or restricts the reproduction of the video content or the like.

Next, details of each of the driving assistance ECU 50a and the automated driving ECU 50b that configures the automated driving system 50 will be described in order.

The driving assistance ECU 50a is a computer mainly including a control circuit including a processing unit, a RAM, a storage, an I/O interface, a bus connecting them, and the like. The driving assistance ECU 50a includes multiple functional units that implement advanced driving assistance by the processing unit executing a program. Specifically, the driving assistance ECU 50a includes an adaptive cruise control (ACC) functional unit, a lane tracking assist (LTA) functional unit, and a lane change assist (LCA) functional unit.

The automated driving ECU 50b has higher calculation capability than the driving assistance ECU 50a, and can execute at least travel control corresponding to ACC, LTA, and LCA. In a scene where the eyes-off automated driving is temporarily interrupted, the automated driving ECU 50b can perform driving assistance control in which the driver is obligated to monitor the periphery instead of the driving assistance ECU 50a.

Similarly to the HCU 100, the automated driving ECU 50b is a computer mainly including a control circuit including a processing unit 51, a RAM 52, a storage 53, an I/O interface 54, a bus connecting them, and the like. The processing unit 51 accesses the RAM 52 to execute various processes for implementing the automated driving control method of the present disclosure. The storage 53 stores various programs (automated driving control program, etc.) to be executed by the processing unit 51. By executing the program by the processing unit 51, the automated driving ECU 50b includes an information cooperation block 60, an environment recognition block 61, an action determination block 62, a control execution block 63, and the like as multiple functional units for implementing the automated driving function. In the drawings, the term of “block” may be omitted.

The information cooperation block 60 provides information to the HCU 100 and acquires information from the HCU 100. Specifically, the information cooperation block 60 generates control status information indicating the operating state of the automated driving function, and provides the generated control status information to the HCU 100. In addition, the information cooperation block 60 outputs a notification execution request to the HCU 100 to enable notification by the HCU 100 in synchronization with the operating state of the automated driving function. Further, the information cooperation block 60 acquires the driver operation information, posture information, task information, and the like from the HCU 100. Based on the operation information, the information cooperation block 60 grasps the content of user operations input to the CID 22, the operation device 26, and the like. Further, the information cooperation block 60 also provides the driver posture information and task information to the action determination block 62.

The environment recognition block 61 combines the locator information and the map data acquired from the locator 35 with the detection information acquired from the periphery monitoring sensor 30 to recognize the traveling environment of the subject vehicle Ao. The environment recognition block 61 has a road grasping unit 161, a different vehicle grasping unit 162, and a traffic congestion recognition unit 163 as sub-functional units for recognizing the traveling environment.

The road grasping unit 161 grasps the type of road on which the subject vehicle Ao is traveling. The road grasping unit 161 acquires, as information indicating a road type, identification information for identifying general roads, motorways, expressways, and the like, and shape information for identifying straight sections, curved sections, merging sections, and the like. The road grasping unit 161 may further acquire information indicating the presence or absence of a median strip, and the like, as the road type information.

The road grasping unit 161 grasps the number of lanes of the road on which the vehicle is traveling, the position of a vehicle lane Lo on which the subject vehicle Ao is traveling, and the like (see FIG. 3 and the like). When the road on which the vehicle is traveling includes multiple lanes, the road grasping unit 161 determines whether the subject vehicle Ao is traveling in a passing lane Lp or a traveling lane Ld. The passing lane Lp is the rightmost lane among multiple lanes under a law requiring vehicles to travel on the left side, and is the leftmost lane among multiple lanes under a law requiring vehicles to travel on the right side. In principle, there is only one passing lane Lp, but multiple passing lanes Lp may be set depending on the road. The traveling lane Ld is a lane other than the passing lane Lp among multiple lanes. The road grasping unit 161 determines that the vehicle is traveling in the traveling lane Ld on a two-lane road.

The different vehicle grasping unit 162 grasps the relative positions, relative speeds, and the like of different vehicles at the periphery of the subject vehicle. The different vehicle grasping unit 162 grasps at least the presence of a front vehicle Af traveling ahead of the subject vehicle Ao in the subject vehicle lane Lo and side vehicles As1 and As2 traveling in adjacent lanes La1 and La2 that are adjacent to the subject vehicle lane Lo and positioned on the both sides. The side vehicles As1 and As2 are vehicles that travel parallel to the subject vehicle Ao, and are other vehicles of which vehicle body positions at least partially overlap with a position of the subject vehicle Ao in a width direction of the subject vehicle lane Lo.

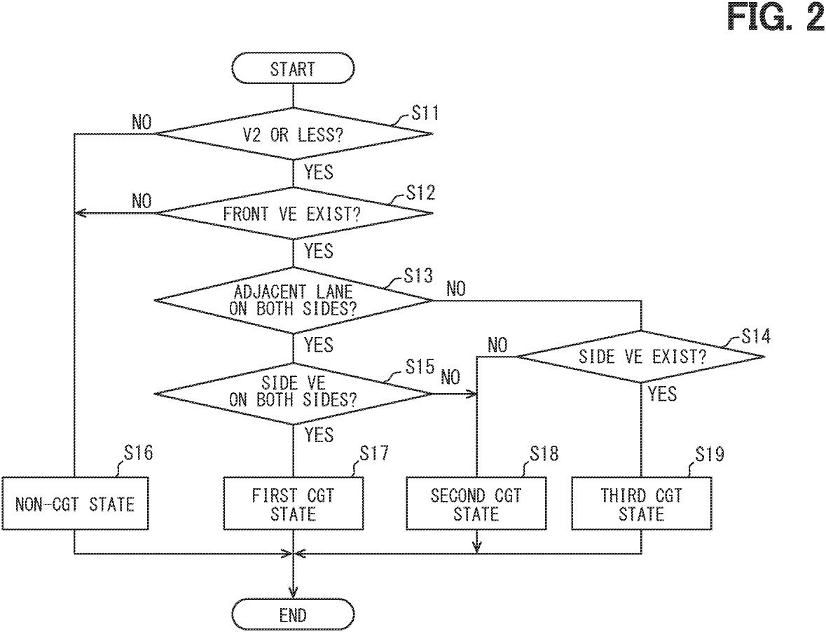

The traffic congestion recognition unit 163 recognizes whether the periphery of the subject vehicle Ao is in a traffic congestion state by using the detection information of the periphery monitoring sensor 30 and the vehicle speed information of the wheel speed sensor 41. Specifically, the traffic congestion recognition unit 163 executes the traffic congestion recognition process (see FIG. 2) to determine whether the vehicle is in a traffic congestion state, and to identify the traffic congestion state at the periphery of the subject vehicle. The traffic congestion recognition unit 163 starts the traffic congestion recognition process based on the activation of the automated driving ECU 50b, and repeats the traffic congestion recognition process until the automated driving ECU 50b is turned off.

Based on the vehicle speed information, the traffic congestion recognition unit 163 determines whether the current vehicle speed of the subject vehicle Ao is equal to or lower than a traffic congestion speed V2 (for example, 10 km/h, see FIG. 11) (S11). When the vehicle speed of the subject vehicle Ao exceeds the traffic congestion speed V2 (S11: NO), the traffic congestion recognition unit 163 determines that there is no traffic congestion (determines the current state as a no-traffic congestion state) (S16). On the other hand, when the vehicle speed of the subject vehicle Ao is equal to or lower than the traffic congestion speed V2 (S11: YES), the traffic congestion recognition unit 163 determines whether there is the front vehicle Af (S12). When the front vehicle Af does not exist (S12: NO), the traffic congestion recognition unit 163 determines that there is no traffic congestion (S16).

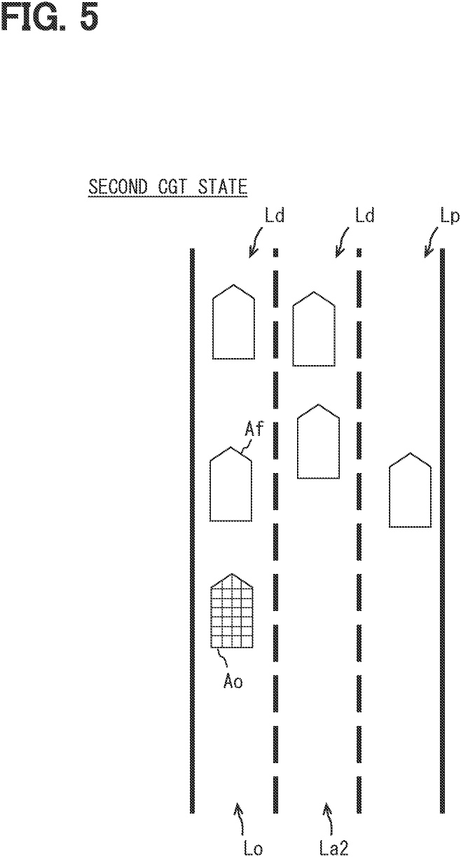

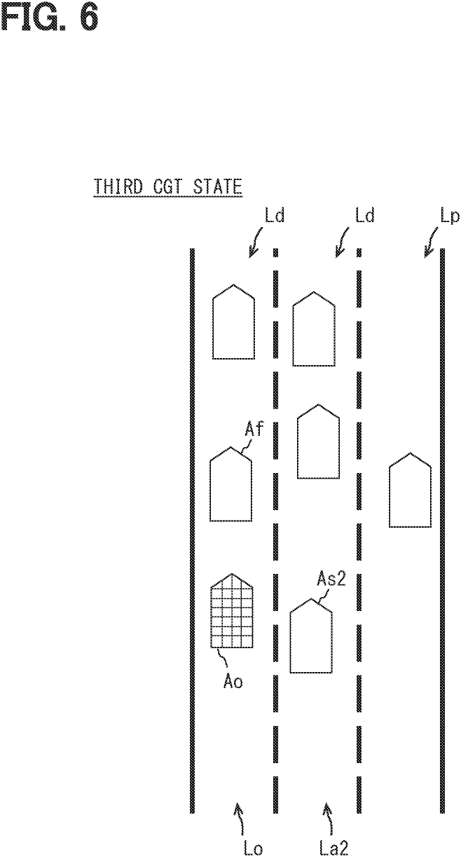

When the vehicle speed is equal to or lower than the traffic congestion speed V2 and the front vehicle Af exists, the traffic congestion recognition unit 163 determines whether the adjacent lanes La1 and La2 exist on both sides of the subject vehicle lane Lo (S13). When the adjacent lane La2 exists only on one side with respect to the subject vehicle lane Lo (S13: NO), the traffic congestion recognition unit 163 determines whether the side vehicle As2 exists on the adjacent lane La2 positioned on one side (S14). When the side vehicle As2 exists (S14: YES), the traffic congestion recognition unit 163 identifies that the peripheral area of the subject vehicle is in the third traffic congestion state (see FIG. 6) (S19). Even when there are no adjacent lanes La1 and La2 of each which advancing direction is same as that of the subject vehicle lane Lo, the traffic congestion recognition unit 163 can determine that the peripheral area of the subject vehicle is in the third traffic congestion state. On the other hand, when the side vehicle As2 does not exist (S14: NO), the traffic congestion recognition unit 163 determines that the peripheral area of the subject vehicle is in the second traffic congestion state (see FIG. 5) (S18).

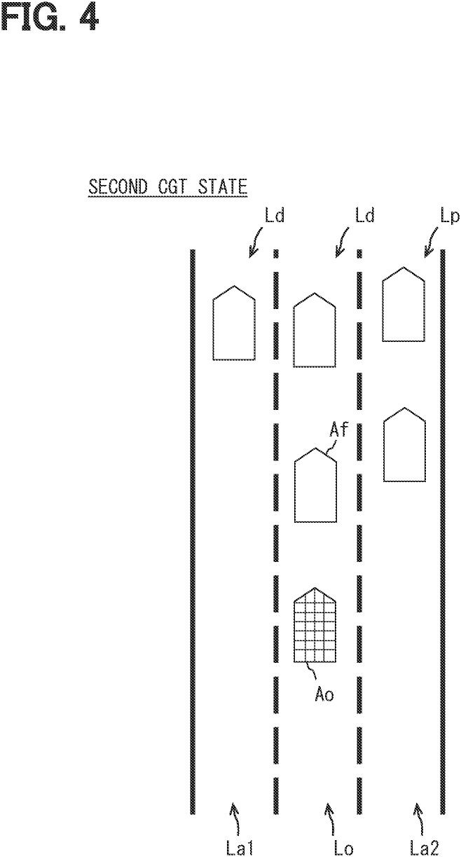

On the other hand, when the adjacent lane La2 exists only on both sides with respect to the subject vehicle lane Lo (S13: YES), the traffic congestion recognition unit 163 determines whether the side vehicles As1 and As2 exist on the adjacent lanes La1 and La2 positioned on both sides (S15). When the side vehicles As1 and As2 do not exist in at least one of adjacent lanes La1 or La2 (S15: NO), the traffic congestion recognition unit 163 determines that the peripheral area of the subject vehicle is in the second traffic congestion state (see FIG. 4) (S18). On the other hand, when the side vehicles As1 and As2 exist in the left and right sides of the subject vehicle Ao (S15: YES), the traffic congestion recognition unit 163 determines that the peripheral area of the subject vehicle is in the first traffic congestion state (see FIG. 3) (S17).

After determining that the periphery of the subject vehicle is in one of the first to third traffic congestion states, the traffic congestion recognition unit 163 recognizes that the traffic congestion state is solved based on the detection information or the vehicle speed information. Specifically, when the current vehicle speed of the subject vehicle Ao exceeds the traffic congestion solving speed V1 (for example, 60 km/h, see FIG. 11), or that the vehicle speed of the front vehicle Af indicated by the detection information exceeds the traffic congestion solving speed V1, the traffic congestion recognition unit 163 recognizes that the traffic congestion state at the periphery of the subject vehicle is solved.

Details of the first, second, and third traffic congestion states will be further described with reference to FIGS. 3 to 6. In the first traffic congestion state, the vehicle speed of the subject vehicle Ao is less than or equal to the traffic congestion speed V2, and, as shown in FIG. 3, all of the front vehicle Af in front of the subject vehicle and the side vehicles As1 and As2 exist. In the first traffic congestion state, it is substantially impossible to change the traveling lane to adjacent lanes La1 and La2.

In the second traffic congestion state, the vehicle speed of the subject vehicle Ao is equal to or less than the traffic congestion speed V2, the front vehicle Af exists, and no side vehicles As1 and As2 exist in at least one of the adjacent lanes La1 or La2. As shown in FIG. 4, in addition to the scene where no side vehicles As1 and As2 exist in the adjacent lanes La1 and La2 positioned on both sides of the subject vehicle, the second traffic congestion state further includes a scene where the side vehicles As1 and As2 exist in only one of the adjacent lanes La1 and La2. Furthermore, as shown in FIG. 5, in a scene where the adjacent lane La2 exists only on one side of the subject vehicle lane Lo, the second traffic congestion state is a state where the side vehicle As2 does not exist in the adjacent lane La2 that is only one adjacent lane in this situation.

The third traffic congestion state is a traffic congestion state in the scene where the adjacent lane La2 exists on only one side of the subject vehicle lane Lo. In the third traffic congestion state, the vehicle speed of the subject vehicle Ao is equal to or less than the traffic congestion speed V2, and, as shown in FIG. 6, both of the front vehicle Af in front of the subject vehicle and the side vehicle As2 in only one adjacent lane La2 exist. The third traffic congestion state is one of the congestion states included in the first traffic congestion state. In the third traffic congestion state, it becomes substantially impossible to change the traveling lane to the adjacent lane La2.

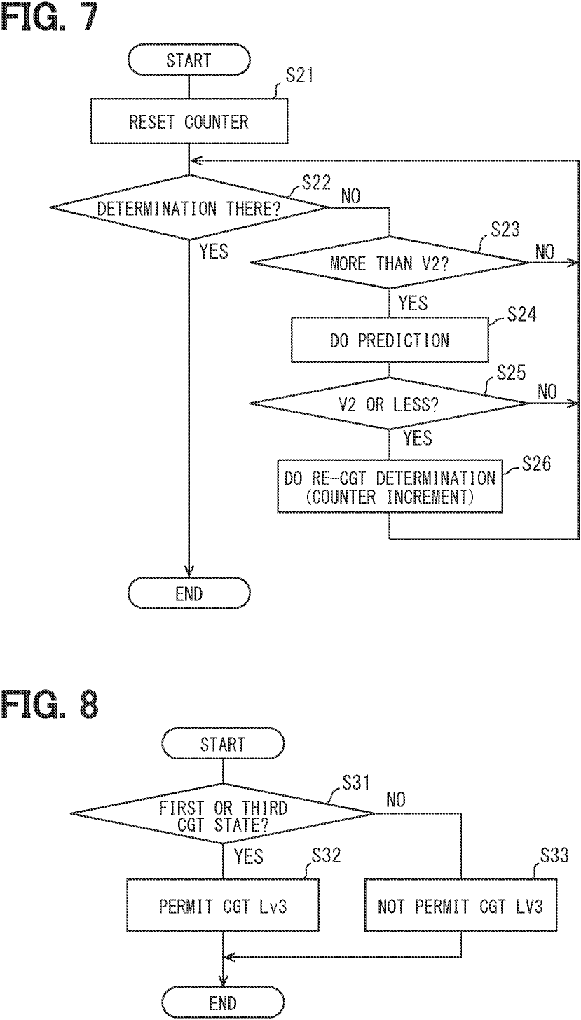

The traffic congestion recognition unit 163 shown in FIG. 1 starts the re-traffic congestion counting process (see FIG. 7) after determining that the periphery of the subject vehicle is in the first traffic congestion state or the third traffic congestion state. In the drawings, the term of “unit” may be omitted. The traffic congestion recognition unit 163 predicts that the traffic congestion is solved by performing re-traffic congestion count process, and counts the number of times the traffic congestion occurs again after the prediction that the traffic congestion is solved. The traffic congestion recognition unit 163 includes a re-traffic congestion counter 164 that counts the number of times that traffic congestion occurs again.

The traffic congestion recognition unit 163 resets the value of the re-traffic congestion counter 164 in the re-traffic congestion count process (S21). The traffic congestion recognition unit 163 refers to the determination result, which is obtained by the action determination block 62 and indicates that the traffic congestion is solved (S22). The traffic congestion recognition unit 163 predicts that the traffic congestion is going to be solved when there is no determination that the traffic congestion has been solved. Specifically, when the vehicle speed of the subject vehicle Ao exceeds the traffic congestion speed V2 (S23: YES), the traffic congestion recognition unit 163 predicts that the traffic congestion at the periphery of the subject vehicle is going to be solved (S24).

After predicting that the traffic congestion is going to be solved, the traffic congestion recognition unit 163 determines whether the vehicle speed of the subject vehicle Ao is equal to or less than the traffic congestion speed V2 (S25). When the vehicle speed of the subject vehicle Ao has decreased to the traffic congestion speed V2 or less (S25: YES), the traffic congestion recognition unit 163 cancels the traffic congestion solving prediction, determines that the traffic congestion has occurred again, and increments the re-traffic congestion counter 164 ( +1) (S26). Thereby, the number of times the traffic congestion occurred again is recorded in the re-traffic congestion counter 164.

The action determination block 62 cooperates with the HCU 100 to control the driving switching between the automated driving system 50 and the driver. When the automated driving system 50 has the right to control the driving operation, the action determination block 62 generates a traveling plan for causing the subject vehicle Ao to travel based on the recognition result of the traveling environment by the environment recognition block 61. In addition, the action determination block 62 includes a posture grasping unit 171, a task grasping unit 172, a time measuring unit 173, a traffic congestion information acquisition unit 174, and a permission controller 177 as sub-function units for controlling the operating state of the automated driving function. In the drawings, the terms of “information” and “acquisition” may be also referred to as “INFO” and “ACQ”.

The posture grasping unit 171 and the task grasping unit 172 cooperate with the driver grasping unit 73 to grasp the state of the driver. The posture grasping unit 171 acquires the driver posture information output by the driver grasping unit 73 and grasps whether the driving posture of the driver is in an appropriate state. The task grasping unit 172 acquires the task information output by the driver grasping unit 73, and grasps the content of the second task that the driver performs during the eyes-off automated driving period. The task grasping unit 172 determines whether the second task being executed has content causing the driver to easily deal with the driver switch. For example, a second task that occupies the driver hand such as operating a smartphone is determined to be difficult to cause the driver to deal with the driver switch. On the other hand, it is determined that the second task, such as viewing moving image content displayed on the CID 22, which does not occupy the driver hands, can cause the driver to easily deal with the driver switch.

The posture grasping unit 171 may acquire driver status information, reclining information, steering grip information, and the like, and grasp the driver driving posture without depending on the information acquired from the driver grasping unit 73. Similarly, the task grasping unit 172 may grasp the content of the second task by acquiring the driver status information from the driver monitor 29 without relying on the information obtained from the driver grasping unit 73.

The time measuring unit 173 measures an elapsed time from the start of the eyes-off automated driving. When detecting that the eyes-off automated driving has started (see time t1 in FIG. 11), the driver grasping unit 73 resets the value of the timer and starts measuring the elapsed time. The time measuring unit 173 continues measuring the elapsed time until the eyes-off automated driving ends (see time t7 in FIG. 11).

The traffic congestion information acquisition unit 174 acquires traffic congestion information received by the V2X communication device 39. Based on the acquired traffic congestion information, the traffic congestion information acquisition unit 174 grasps whether the road on which the subject vehicle Ao is scheduled to travel is in the traffic congestion state. The traffic congestion information acquisition unit 174 acquires input information output by the driver grasping unit 73. Based on the acquired input congestion information, the traffic congestion information acquisition unit 174 grasps the driver determination result indicating whether the road on which the subject vehicle Ao is scheduled to travel is in the traffic congestion state.

The permission controller 177 controls the start and end of the traffic congestion Level 3 eyes-off automated driving of which execution is limited to traveling during the traffic congestion. The permission controller 177 may control the start and end of the eyes-off automated driving with an execution pattern different from that at the Level 3 during the traffic congestion, for example, area Level 3 automated driving that is performed only in a specific automated driving permission area. The eyes-off automated driving in this embodiment corresponds to an autonomous driving control at Level 3 during the traffic congestion.

The permission controller 177 determines whether to permit the start of automated driving at Level 3 during the traffic congestion by executing the automated driving permission process (see FIG. 8). The automated driving at Level 3 during the traffic congestion may be also referred to as traffic congestion Level 3 automated driving. The permission controller 177 repeatedly executes the automated driving permission process while the eyes-off automated driving is in a standby state.

The permission controller 177 refers to the result of the traffic congestion recognition process executed by the traffic congestion recognition unit 163, and determines whether the periphery of the subject vehicle is in the first traffic congestion state (see FIG. 3) or the third traffic congestion state (see FIG. 6) (S31). When the periphery of the subject vehicle is in the first traffic congestion state or the third traffic congestion state (S31: YES), the permission controller 177 permits the start of traffic congestion Level 3 automated driving (S32). In this case, the permission controller 177 starts the eyes-off automated driving in response to a trigger that is an input of the activation operation to the operation device 26 or the like by the driver. On the other hand, when the periphery of the subject vehicle is in the second traffic congestion state (see FIGS. 4 and 5) or in a non-congestion state (S31: NO), the permission controller 177 does not permit the start of traffic congestion Level 3 automated driving (S33).

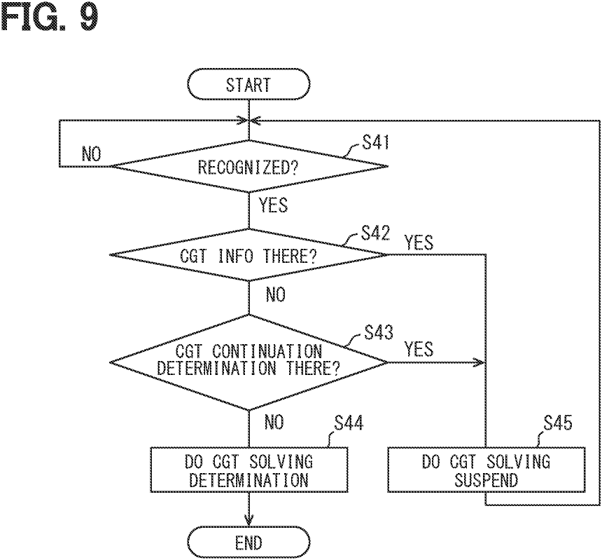

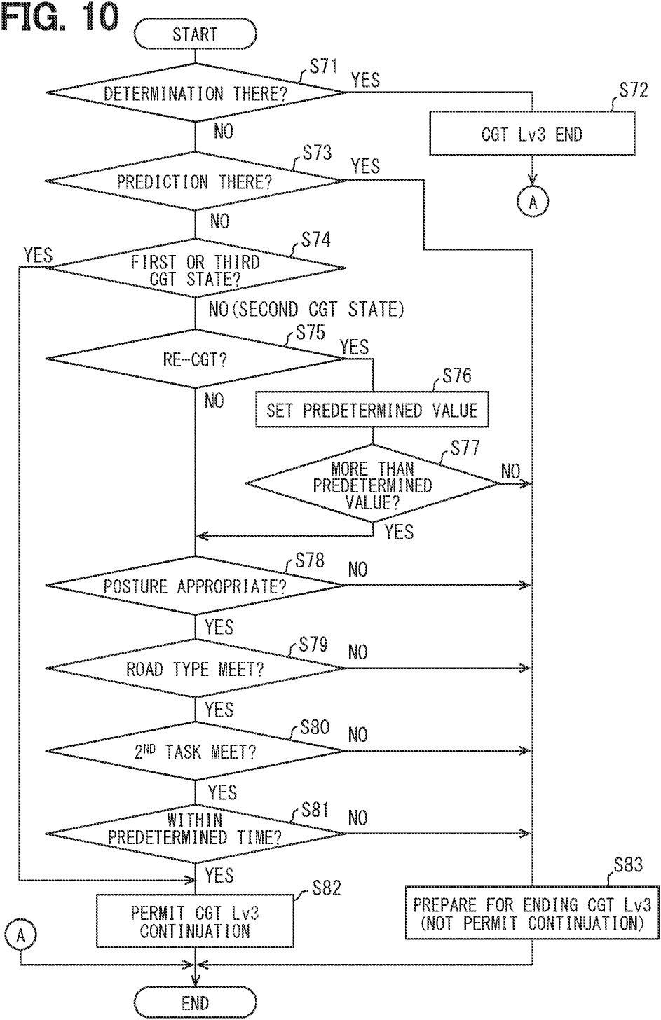

The permission controller 177 repeats the traffic congestion solving determination process (see FIG. 9) and the state control process (see FIG. 10) after starting the traffic congestion Level 3 automated driving. The traffic congestion solving determination process is a process in which the permission controller 177 makes a final determination of determining whether the traffic congestion at the periphery of the subject vehicle has been solved.

In the traffic congestion solving determination process (S41), the permission controller 177 refers to the recognition result, which is obtained from the traffic congestion recognition unit 163 and indicates that the traffic congestion is solved. When the current vehicle speed of the subject vehicle Ao or the front vehicle Af is equal to or lower than the traffic congestion solving speed V1 and it is not recognized that the traffic congestion has been solved (S41: NO), the permission controller 177 continues the traffic congestion solving determination process. On the other hand, when the vehicle speed of the subject vehicle Ao exceeds the traffic congestion solving speed V1 and it is recognized that the traffic congestion state has been solved (S41: YES), the permission controller 177 determines whether the traffic congestion information acquisition unit 174 has acquired the traffic congestion information (S42). If the traffic congestion information has been acquired (S42: YES), the permission controller 177 regards that the traffic congestion in the advancing direction continues, and suspends the traffic congestion solving determination by the traffic congestion recognition unit 163 (S45). Thereby, the end of the traffic congestion Level 3 automated driving is suspended.

On the other hand, when the traffic congestion information acquisition unit 174 has not acquired the traffic congestion information (S42: NO), the permission controller 177 determines whether input information has been acquired by the traffic congestion information acquisition unit 174 (S43). When the input information of the driver who has determined that the traffic congestion will continue has been acquired (S43: YES), the permission controller 177 suspends the determination that is performed by the traffic congestion recognition unit 163 and indicates whether the traffic congestion has been solved (S45). In this case as well, the end of traffic congestion Level 3 automated driving is suspended. On the other hand, when there is no input information acquired by the traffic congestion information acquisition unit 174 (S43: NO), the permission controller 177 determines that the traffic congestion state has been solved (S44).

In the state control process (see FIG. 10), the permission controller 177 refers to the result of the traffic congestion resolving determination by the traffic congestion solving determination process (S71). When there is the fixed determination that the congestion has been solved (S71: YES), the permission controller 177 ends the traffic congestion Level 3 automated driving (S72). In this case, the permission controller 177 shifts the control from the eyes-off automated driving to the automated driving in which the driving assistance ECU 50a is obligated to monitor the periphery.

On the other hand, there is no fixed determination the traffic congestion has been solved (S71: NO), the permission controller 177 refers to the result of the traffic congestion solving prediction (see S24 in FIG. 7) by the traffic congestion recognition unit 163 (S73). The traffic congestion solving prediction may mean a prediction that the traffic congestion is going to be solved. When there is the traffic congestion solving prediction (S73: YES), the permission controller 177 does not permit the continuation of the traffic congestion Level 3 automated driving, and prepares for the end of the automated driving (S83). In such a manner, the permission controller 177 starts the preparation for ending the eyes-off automated driving when, after the start of the eyes-off automated driving permitted based on the recognition of the congestion state, the vehicle speed of the subject vehicle Ao exceeds the traffic congestion speed V2 and the traffic congestion is predicted to be solved. On the other hand, when there is no traffic congestion solving prediction (S73: NO), the permission controller 177 determines whether the traffic congestion state at the periphery of the subject vehicle is in the first traffic congestion state or the third traffic congestion state (S74).

When the periphery of the subject vehicle is in the first traffic congestion state or the third traffic congestion state (S74: YES), the permission controller 177 permits the continuation of traffic congestion Level 3 automated driving (S82). On the other hand, in a case where the periphery of the subject vehicle is in the second traffic congestion state (S74: NO), when all of the multiple predetermined conditions (S75, S77 to S81) are satisfied, the permission controller 177 permits the continuation of the traffic congestion Level 3 automated driving.

The permission controller 177 determines whether the traffic congestion is the first time traffic congestion causing the eyes-off automated driving to start or the traffic congestion again after the traffic congestion speed V2 is once exceeded (S75). When the permission controller 177 determines that the traffic congestion has not occurred again (S75: NO), the permission controller 177 permits the continuation of the traffic congestion Level 3 automated driving. On the other hand, when it is determined that the traffic congestion has occurred again (S75: YES), the permission controller 177 sets a predetermined number of times as a determination threshold according to the position of the subject vehicle lane Lo (S76). The permission controller 177 changes the predetermined number of times according to the position of the subject vehicle lane Lo. When the adjacent lane La2 exists only on one side of the subject vehicle lane Lo or when the adjacent lanes La1 and La2 do not exist, the permission controller 177 sets a predetermined number of times to be lower than the predetermined number of times in a case where the adjacent lanes La1 and La2 exist on both sides of the subject vehicle lane Lo. In one example, when no adjacent lanes La1 and La2 exist on both sides of the subject vehicle lane Lo, the predetermined number of times is set to once. When the adjacent lanes La1 and La2 exist on both sides of the subject vehicle lane Lo, the predetermined time is set to about several times.

The permission controller 177 compares the predetermined number of times corresponding to the position of the subject vehicle lane Lo with the value of the re-traffic congestion counter 164 (S77). When the re-traffic congestion occurrence count is equal to or less than the predetermined number of times (S77: NO), the permission controller 177 does not permit continuation of the eyes-off automated driving in the second traffic congestion state during the re-traffic congestion (S83). In other words, when the re-traffic congestion occurrence count is equal to or less than the predetermined number of times, the continuation of the eyes-off automated driving during the re-traffic congestion is permitted only in the first traffic congestion state. On the other hand, when the re-traffic congestion occurrence count exceeds the predetermined number of times (S77: YES) and other conditions (S78 to S81) are satisfied, the permission controller 177 permits the continuation of the eyes-off automated driving in the second traffic congestion state during the re-traffic congestion (S82).

The permission controller 177 determines whether to permit the continuation of the eyes-off automated driving in the second traffic congestion state according to the driver driving posture (S78). When the driver driving posture grasped by the posture grasping unit 171 is not in an appropriate state (S78: NO), the permission controller 177 does not permit the continuation of the eyes-off automated driving in the second traffic congestion state and performs the end preparation at the Level 3 during the traffic congestion (S83). For example, when a backrest of a driver seat is tilted backward beyond a predetermined angle, when the driver is in a posture that makes it difficult to monitor the periphery, or when it is difficult to grip the steering wheel, the permission controller 177 does not permit the continuation of the eyes-off automated driving. On the other hand, when the driver driving posture is in an appropriate state (S78: YES) and other conditions (S79 to S81) are satisfied, the permission controller 177 permits the continuation of the traffic congestion Level 3 automated driving (S82). For example, when a reclining of the driver seat is equal to or less than a predetermined value, when the driver is in a posture that makes it possible to monitor the periphery, or when the driver is in a posture that makes it possible to grip the steering wheel, the permission controller 177 permits the continuation of the eyes-off automated driving.

The permission controller 177 determines whether to permit the continuation of the eyes-off automated driving in the second traffic congestion state according to the road type (S79). When the traveling road type grasped by the road grasping unit 161 does not meet the continuation permission condition (S79: NO), the permission controller 177 does not permit the continuation of the eyes-off automated driving in the second traffic congestion state and performs the end preparation at the Level 3 during the traffic congestion (S83). For example, when the road on which the vehicle is traveling is a curve section or a merging section, the permission controller 177 does not permit the continuation of the eyes-off automated driving. On the other hand, when the traveling road type meets the continuation permission condition (S79: YES) and other conditions (S78, S80, and S81) are satisfied, the permission controller 177 permits the continuation of the traffic congestion Level 3 automated driving (S82). For example, when the road on which the vehicle is traveling is a straight section, the permission controller 177 can permit the continuation of the eyes-off automated driving.

The permission controller 177 determines whether to permit the continuation of the eyes-off automated driving in the second traffic congestion state according to the content of the second task (S80). When the second task is being executed and the content grasped by the task grasping unit 172 does not meet the continuation permission condition (S80: NO), the permission controller 177 does not permit the continuation of the eyes-off automated driving in the second traffic congestion state and performs the end preparation at the Level 3 during the traffic congestion (S83). For example, when both hands of the driver are occupied by operating a smartphone or the like, the permission controller 177 does not permit the continuation of the eyes-off automated driving. On the other hand, when the content of the second task, which is being executed, meet the continuation permission condition (S80: YES) and other conditions (S78, S79, and S81) are satisfied, the permission controller 177 permits the continuation of the traffic congestion Level 3 automated driving (S82). For example, when both hands of the driver are not occupied in a situation where the driver operates the CID 22 or the like, the permission controller 177 can permit the continuation of the eyes-off automated driving.

The permission controller 177 determines whether to permit the continuation of the eyes-off automated driving in the second traffic congestion state according to the elapsed time from the start of the automated driving (S81). When the elapsed time measured by the time measuring unit 173 exceeds a predetermined time (for example, one minute) (S81: NO), the permission controller 177 does not permit the continuation of the eyes-off automated driving in the second traffic congestion state and performs the end preparation at the Level 3 during the traffic congestion (S83). On the other hand, when the elapsed time is within the predetermined time (S81: YES) and other conditions (S78 to S80) are satisfied, the permission controller 177 permits the continuation of the traffic congestion Level 3 automated driving (S82).

The control execution block 63 performs acceleration-deceleration control and steering control of the subject vehicle Ao according to the travel plan generated by the action determination block 62 in cooperation with the travel control ECU 40 when the automated driving system 50 has the right to control the driving operation. Specifically, the control execution block 63 generates control commands based on the travel plan, and sequentially outputs the generated control commands to the travel control ECU 40.

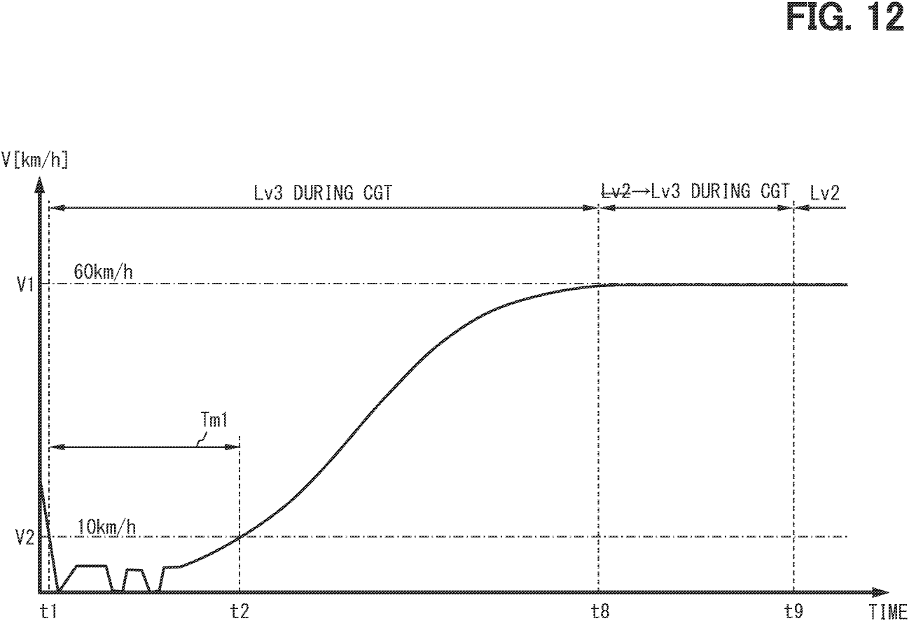

Next, multiple traffic congestion scenes in which the automated driving ECU 50b described above performs the traffic congestion Level 3 automated driving will be described based on FIGS. 11 and 12 and with reference to FIG. 1.

In the traffic congestion scene shown in FIG. 11, the vehicle speed of the subject vehicle Ao repeatedly rises and falls across the traffic congestion speed V2. Upon recognizing that the periphery of the subject vehicle is in the first traffic congestion state or third traffic congestion state at time t1 when the vehicle speed becomes equal to or lower than the traffic congestion speed V2, the automated driving ECU 50b starts the traffic congestion Level 3 automated driving. The automated driving ECU 50b continues the traffic congestion Level 3 automated driving during a first traffic congestion period Tm1 from time t1 to time t2 when the vehicle speed exceeds the traffic congestion speed V2. In the first traffic congestion period Tm1, even in a case where the periphery of the subject vehicle transitions to the second traffic congestion state, when the conditions such as the driving posture, the road type, and the content of the second task are satisfied, the traffic congestion Level 3 automated driving is permitted to continue.

At time t2, the automated driving ECU 50b does not permit the traffic congestion Level 3 automated driving based on the prediction that the traffic congestion is going to be solved, and starts the preparation for ending the automated driving. Even after the time t2 at which the preparation for ending the automated driving starts, the automated driving ECU 50b continues the automated control of the driving operation and accelerates the subject vehicle Ao while following the front vehicle Af. In the traffic congestion scene of FIG. 11, the traffic congestion at the periphery of the subject vehicle is not solved, so the vehicle speed decreases without exceeding the traffic congestion solving speed V1.

At time t3, when the vehicle speed becomes equal to or lower than the traffic congestion speed V2, the automated driving ECU 50b cancels the prediction that the traffic congestion is going to be solved and determines that the traffic congestion will occur again. A second traffic congestion period Tm2 from time t3 to time t4, at which the vehicle speed again exceeds the traffic congestion speed V2, is the first re-traffic congestion period. The automated driving ECU 50b permits the traffic congestion Level 3 automated driving only when the periphery of the subject vehicle is in the first traffic congestion state or the third traffic congestion state during the second traffic congestion period Tm2. On the other hand, when the periphery of the subject vehicle is in the second traffic congestion state, the traffic congestion Level 3 automated driving is not permitted during the second traffic congestion period Tm2.

At time t4, the automated driving ECU 50b predicts again that the traffic congestion is going to be solved . In the second traffic congestion period Tm2, when the traffic congestion Level 3 automated driving has been permitted, the automated driving ECU 50b again does not permit the traffic congestion Level 3 automated driving, and starts the preparation for ending the automated driving.

At time t5, when the vehicle speed becomes equal to or lower than the traffic congestion speed V2 again, the automated driving ECU 50b cancels the prediction that the traffic congestion is going to be solved and determines that the second re-traffic congestion has occurred. During a third traffic congestion period Tm3 from time t5 to time t6 when the vehicle speed again exceeds the traffic congestion speed V2, the traffic congestion Level 3 automated driving is permitted even when the periphery of the subject vehicle is in the second traffic congestion state.

At time t6, the automated driving ECU 50b predicts that the traffic congestion is going to be solved again and does not permit the traffic congestion Level 3 automated driving again, and starts the preparation for ending the automated driving. Further, at time t7, when the vehicle speed exceeds the traffic congestion solving speed V1, the automated driving system 50 switches from the eyes-off automated driving to the level 2 automated driving with the obligation to monitor the periphery.

In cooperation with the automated driving control of the automated driving ECU 50b, the HCU 100 grasps the permission state of the traffic congestion Level 3 automated driving at the time t1 and permits the execution of the second task by the driver. The HCU 100 provides video content or the like related to the second task, for example, during the first traffic congestion period Tm1. At time t2, upon recognizing switching of the traffic congestion Level 3 automated driving from the permission state to non-permission state, the HCU 100 restricts the reproduction of the video content and provides a notification to encourage monitoring of the periphery.

The HCU 100 permits the execution of the second task again when the traffic congestion Level 3 automated driving is resumed during the second traffic congestion period Tm2 and the third traffic congestion period Tm3. As a result, the restriction on provision of the video content applied at time t2 or time t4 is released. On the other hand, in the second traffic congestion period Tm2, when the traffic congestion Level 3 automated driving is not resumed, the HCU 100 does not permit the execution of the second task. In this case, viewing restrictions on the video content are maintained. When the HCU 100 again does not permit the execution of the second task at time t4 and time t6, the HCU 100 resumes the notification to encourage monitoring of the periphery. Further, the HCU 100 completely ends the provision of video content at time t7 when the traffic congestion Level 3 automated driving is canceled. Furthermore, the HCU 100 switches the display to contents suitable for the level 2 automated driving (driving assistance).

In the traffic congestion scene shown in FIG. 12, even after the vehicle speed reaches the traffic congestion solving speed V1, the end of the traffic congestion Level 3 automated driving is suspended. As in the traffic congestion scene described above, the automated driving ECU 50b starts the traffic congestion Level 3 automated driving at time t1 when the vehicle speed is equal to or lower than the traffic congestion speed V2.The automated driving ECU 50b continues the traffic congestion Level 3 automated driving during a first traffic congestion period Tm1 to the time t2 when the vehicle speed exceeds the traffic congestion speed V2. At the time t2, the automated driving ECU 50b predicts that the traffic congestion is going to be solved, and starts the preparation for ending the automated driving.

At time t2, the HCU 100 starts the notification to encourage monitoring of the periphery when the Level 3 traffic congestion automated driving is not permitted. In addition, the HCU 100 provides a notification to encourage the driver to input whether the traffic congestion continues on the scheduled route. When the HCU 100 acquires a driver input indicating the continuation of traffic congestion, the HCU 100 outputs the input information of the user operation by the driver to the automated driving ECU 50b.

In a case where the automated driving ECU 50b acquires either the traffic congestion information indicating the continuation of the traffic congestion or the driver input information, even when the vehicle speed reaches the traffic congestion solving speed V1 at time t8, the automated driving ECU 50b suspends the end of the traffic congestion Level 3 automated driving. That is, even when the automated driving ECU 50b recognizes that the traffic congestion at the periphery of the subject vehicle has been solved from sensor information by the wheel speed sensor 41, the periphery monitoring sensor 30, or the like, the automated driving ECU 50b trusts the traffic congestion information received from outside the vehicle or determination by the driver, and does not cancel the traffic congestion Level 3 automated driving. At time t9 when a traffic congestion end point indicated by the traffic congestion information is passed or the input information indicating that the traffic congestion has been solved is acquired, the automated driving ECU 50b ends the traffic congestion Level 3 automated driving, and performs switching to the level 2 automated driving with the periphery monitoring obligation.

When the end of the traffic congestion level automated driving is suspended at the time t8, the HCU 100 provides a notification that, before the time t8, the traffic congestion Level 3 automated driving is going to continue. At this time, it may be further carried out in a manner in which the notification to encourage monitoring the periphery is emphasized. The HCU 100 switches the display to contents suitable for the level 2 automated driving when the traffic congestion Level 3 automated driving is canceled at time t9.

In the first embodiment described above, the permission state of the eyes-off automated driving continues even when transition occurs from the first traffic congestion state transitions to the second traffic congestion state after the eyes-off automated driving starts. In this way, when the continuation condition of the eyes-off automated driving is relaxed more than the start condition, it is possible to avoid a situation in which the eyes-off automated driving ends prematurely since started. As described above, it is possible to easily perform the continuous eyes-off automated driving. Therefore, it is possible to ensure the convenience of automated driving.

In addition, in the first embodiment, the elapsed time from the start of the eyes-off automated driving is measured. Then, when the elapsed time is within the predetermined time, the permission controller 177 can permit the continuation of the eyes-off automated driving in the second traffic congestion state. Therefore, when the side vehicles As1 and As2 do not exist temporarily, the eyes-off automated driving can be continued without being canceled. On the other hand, when the elapsed time exceeds the predetermined time, the continuation of the eyes-off automated driving in the second traffic congestion state is not permitted. Therefore, when a state where the side vehicle As1, As2 do not exist continues after the start of the eyes-off automated driving, the permission controller 177 can cancel the eyes-off automated driving. The time measuring unit 173 may measure the elapsed time after the transition from the first traffic congestion state to the second traffic congestion state instead of the elapsed time after the start of the eyes-off automated driving.

Further, in the first embodiment, the driving posture of the driver is grasped, the permission controller 177 determines whether to permit the continuation of the eyes-off automated driving in the second traffic congestion state according to the driver driving posture. In this way, when the driver driving posture is good, it is possible to cope with interruptions from other vehicles on the adjacent lanes La1 and La2. Therefore, even in the second traffic congestion state in which the interruptions are likely to occur, the continuation of the eyes-off automated driving without the obligation to monitor the periphery may be permitted.

On the other hand, when the driver driving posture is not suitable for the driving operation, it may be difficult to cope with the interruptions by other vehicles from the adjacent lanes La1 and La2. Therefore, the permission controller 177 permits the continuation of the eyes-off automated driving only in the first traffic congestion state or the third traffic congestion state in which the interruption is unlikely to occur. According to the above, the eyes-off automated driving can be appropriately continued according to the driver driving posture. Thereby, it is possible to improve the convenience for the driver.

Furthermore, in the first embodiment, the road type on which the subject vehicle Ao is traveling is grasped, and the permission controller 177 determines whether to permit the continuation of the eyes-off automated driving in the second traffic congestion state according to the road type. For example, in a case where the road type is a straight section or the like in which interruptions from other vehicles can be easily recognized, it may be possible to prevent the risk from increasing, even when the continuation of the eyes-off automated driving is permitted in the second traffic congestion state. On the other hand, in the case of a road type such as the curve section or the merging section in which it is difficult to recognize the interruptions, when the continuation of the eyes-off automated driving is permitted in the second traffic congestion state, the risk due to other vehicles increases. As described above, when it is determined whether to continue according to the road type, it is possible to improve the convenience of the automated driving while reducing the risk.

In addition, in the first embodiment, the content of the second task performed by the driver is grasped, and the permission controller 177 determines whether to permit the continuation of the eyes-off automated driving in the second traffic congestion state based on the content of the second task. For example, when the second task does not occupy the driver hands, it is possible to cope with the interruptions by other vehicles from adjacent lanes La1 and La2. Therefore, the continuation of the eyes-off automated driving may be permitted even in the second traffic congestion state. On the other hand, when the second task has a content that, for example, occupies the driver hands, it becomes difficult to cope with the interruption by other vehicles. Therefore, it is preferable to permit the continuation of the eyes-off automated driving only in the first traffic congestion state or the third traffic congestion state. As described above, when it is determined whether to continue according to the second task content, it is possible to improve the convenience of the automated driving while reducing the risk.

Further, in the first embodiment, the re-traffic congestion counter 164 counts the number of times that the re-traffic congestion occurs after the congestion is predicted to be solved. Then, when the count of re-traffic congestion is equal to or less than a predetermined number of times, the continuation of the eyes-off automated driving in the second traffic congestion state is not permitted during the re-traffic congestion. At the beginning of traffic congestion again, the traffic congestion will be highly likely to be solved soon. Therefore, in a case where the count of the re-traffic congestion is equal to or less than the predetermined number of times, the driver can smoothly cope with solving the traffic congestion by deferring the continuation of the automated driving in the second traffic congestion state.

On the other hand, when the count of re-traffic congestion is equal to or less than a predetermined number of times, the continuation of the eyes-off automated driving in the second traffic congestion state is permitted during the re-traffic congestion. When the re-traffic congestion is repeated, the traffic congestion is not likely to be solved soon. Therefore, when the continuation of the automated driving is permitted even in the second traffic congestion state, it becomes possible to improve the convenience of the automated driving while reducing the risk.

Furthermore, in the first embodiment, when the adjacent lane La2 exists only on one side of the vehicle lane Lo, the predetermined number of times is set smaller than that at the time when the adjacent lanes La1 and La2 exist on both sides of the subject vehicle lane Lo. In this way, when the adjacent lane La2 is only on one side, the possibility of interruption is low. Therefore, by adjusting the predetermined number of times according to the number of adjacent lanes La1 and La2, it becomes possible to improve the convenience of the automated driving while reducing the risk.

In addition, in the first embodiment, in the case where, after the start of the eyes-off automated driving, it is recognized that traffic congestion state at the periphery of the subject vehicle has been solved, the end of the eyes-off automated driving is suspended when the traffic congestion is determined to continue based on the traffic congestion information of the road on which the vehicle is scheduled to travel. By preventing the condition for canceling the eyes-off automated driving from being satisfied, it is possible to avoid a situation in which the eyes-off automated driving ends prematurely once started. Accordingly, it is possible to easily perform the continuous eyes-off automated driving. Therefore, it is possible to ensure the convenience of automated driving.

Further, in the first embodiment, in the case where, after the start of the eyes-off automated driving, it is recognized that traffic congestion state at the periphery of the subject vehicle has been solved, the end of the eyes-off automated driving is suspended when the traffic congestion is determined to continue based on the input information according to the driver determination. By preventing the condition for canceling the eyes-off automated driving from being satisfied, it is possible to avoid a situation in which the eyes-off automated driving ends prematurely once started. Accordingly, it is possible to easily perform the continuous eyes-off automated driving. Therefore, it is possible to ensure the convenience of automated driving.

In the above embodiment, the traffic congestion speed V2 corresponds to a “predetermined speed”, each of the periphery monitoring sensor 30 and the wheel speed sensor 41 corresponds to an “autonomous sensor”, and the road grasping unit 161 corresponds to a “road type grasping unit”, and the automated driving ECU 50b corresponds to an “automated driving control device”.

### Second Embodiment

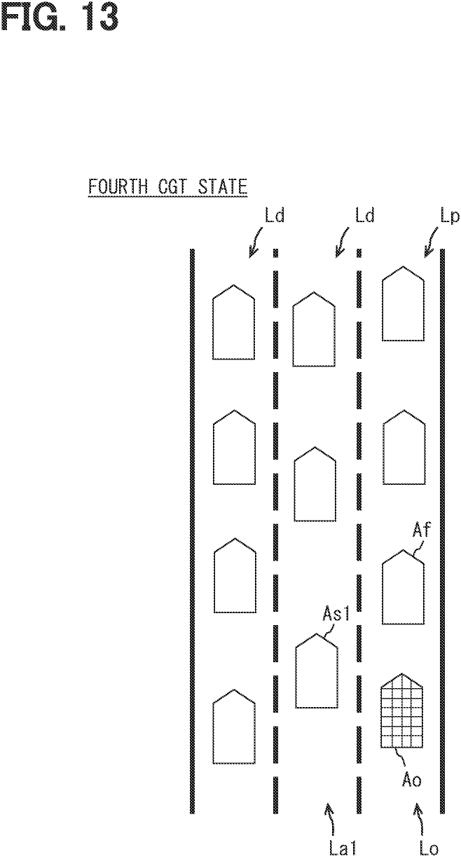

As shown in FIGS. 13 to 19, a second embodiment of the present disclosure is a modification of the first embodiment. In the second embodiment, the contents of the automated driving control by the automated driving ECU 50b and the information presentation control by the HCU 100 are changed depending on whether the subject vehicle lane Lo is the passing lane Lp. Hereinafter, details of the automated driving control and information presentation control of the second embodiment will be described based on FIGS. 13 to 19 and with reference to FIGS. 1 and 3 to 6.

In addition to the first to third traffic congestion states of the first embodiment, the traffic congestion recognition unit 163 further recognizes fourth to sixth traffic congestion states as traffic congestion states at the periphery of the subject vehicle Ao. The fourth to sixth traffic congestion states are traffic congestion states when the subject vehicle Ao travels in the passing lane Lp. On the other hand, the first to third traffic congestion states of the second embodiment mainly indicate the case where the subject vehicle lane Lo becomes the traveling lane Ld.

Similarly to the third traffic congestion state (see FIG. 6), the fourth traffic congestion state (see FIG. 13) is one of the traffic congestion states included in the first traffic congestion state (see FIG. 3). The traffic congestion recognition unit 163 recognizes a state of periphery of the subject vehicle as the fourth traffic congestion state when recognizing the first traffic congestion state, in which the subject vehicle Ao travels in the passing lane Lp, the vehicle speed of the subject vehicle is equal to or less than the traffic congestion speed V2, and also both of the front vehicle Af and the side vehicle As1 exist. In the fourth traffic congestion state, as in the first traffic congestion state, it is substantially impossible to change lanes between the adjacent lane La1 and the subject vehicle lane Lo.

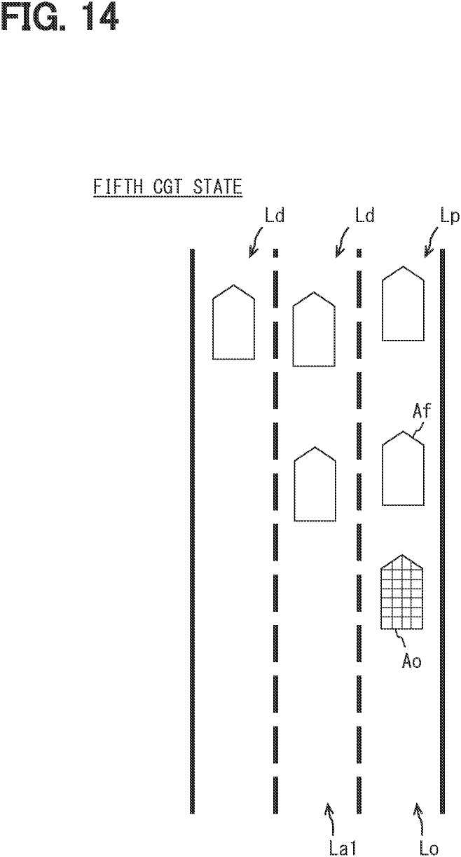

The fifth traffic congestion state (see FIG. 14) is one of the traffic congestion states included in the second traffic congestion state (see FIGS. 4 and 5). The traffic congestion recognition unit 163 recognizes the state of periphery of the subject vehicle as the fifth traffic congestion state when recognizing the first traffic congestion state, in which the subject vehicle Ao travels in the passing lane Lp, the vehicle speed of the subject vehicle is equal to or less than the traffic congestion speed V2, the front vehicle Af exists, and also the side vehicle As1 does not exist. In the fifth traffic congestion state, as in the second traffic congestion state, it is possible to change lanes between the adjacent lane La1 and the subject vehicle lane Lo.

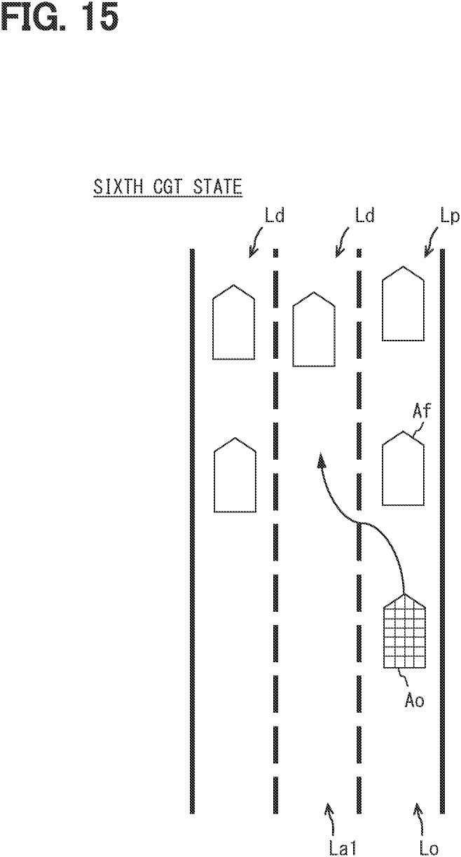

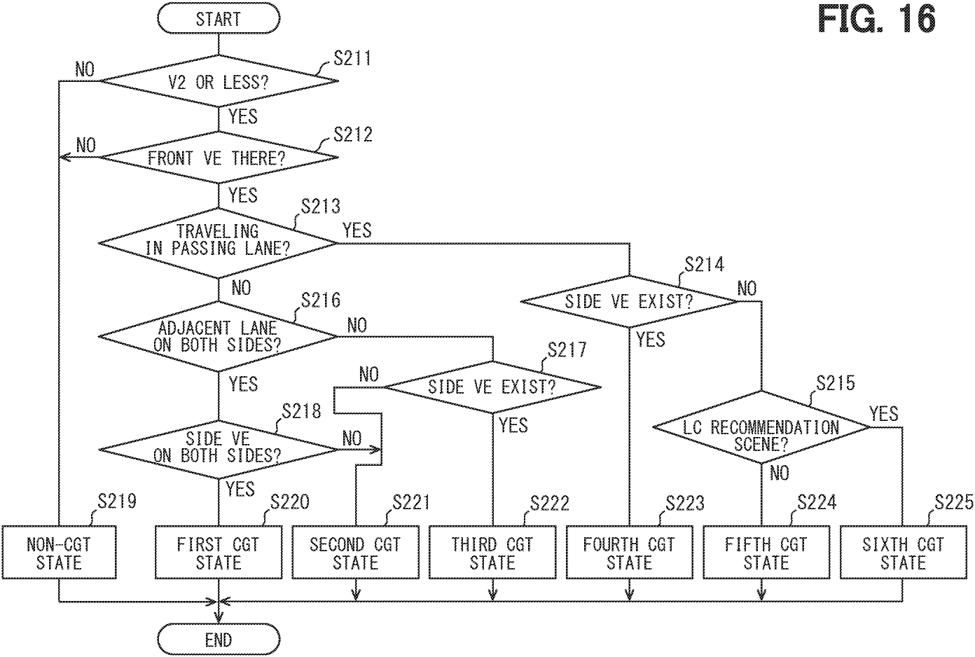

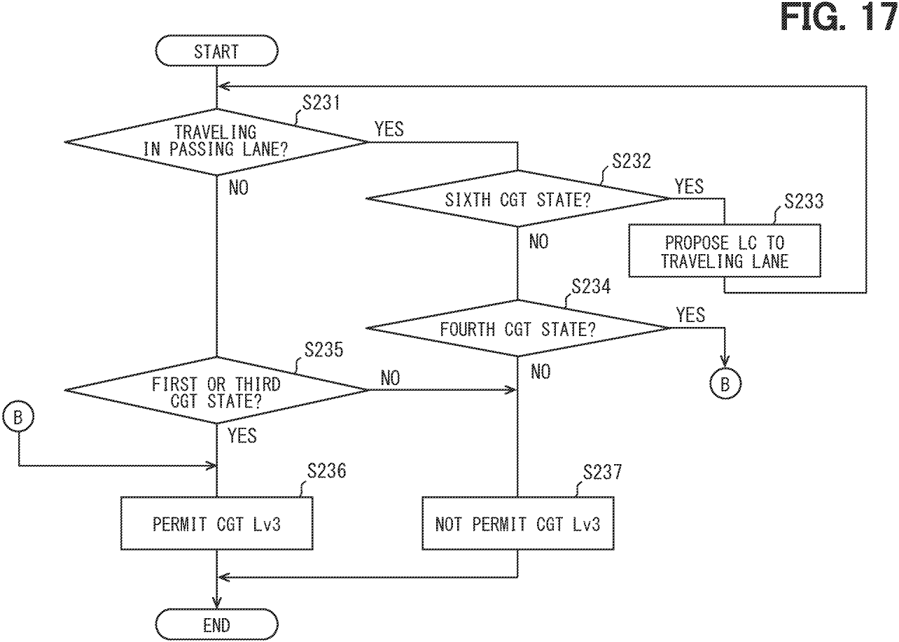

The sixth traffic congestion state (see FIG. 15) is one of the traffic congestion states included in the second traffic congestion state and the fifth traffic congestion state. The traffic congestion recognition unit 163 recognizes the state of the periphery of the subject vehicle as the sixth traffic congestion state when the scene is in the fifth traffic congestion state and also the transition to the first traffic congestion state is possible by change of the vehicle lane from the passing lane Lp to the adjacent lane La1 (traveling lane Ld). When the traffic congestion recognition unit 163 recognizes that the periphery state is in the sixth traffic congestion state, lane change proposal notification (see S233 in FIG. 17) is performed to encourage the driver to change the current lane to the adjacent lane La1.

The traffic congestion recognition unit 163 identifies the above-described first to sixth traffic congestion states by a traffic congestion recognition process (see FIG. 16). Hereinafter, details of the traffic congestion recognition process of the second embodiment will be described. Processes of S211, S222, and S216 to S222 in the second embodiment are substantially the same as processes of S11 to S19 in the first embodiment.

When the vehicle speed of the subject vehicle Ao is equal to or lower than the traffic congestion speed V2 (S211: YES) and the front vehicle Af exists (S212: YES), the traffic congestion recognition unit 163 refers to the lane determination result by the road grasping unit 161, it is determined whether the vehicle is traveling in the passing lane Lp by referring to the lane determination result by the road recognition unit 161 (S213). When the subject vehicle Ao is traveling in the traveling lane Ld (S213: NO), the traffic congestion recognition unit 163 executes a process of identifying the current traffic congestion state at the periphery of the subject vehicle from among the first to third traffic congestion states (S216 to S218, S220 to S222).

On the other hand, when the subject vehicle Ao is traveling in the passing lane Lp (S213: YES), the traffic congestion recognition unit 163 refers to the different vehicle recognition result of the different vehicle grasping unit 162, and determines whether the side vehicle As1 exists in the adjacent lane La1 (S214). When the side vehicle As1 exists in the adjacent lane La1 (S214: YES), the traffic congestion recognition unit 163 identifies that the peripheral area of the subject vehicle is in the fourth traffic congestion state (see FIG. 13) (S223).

On the other hand, when the side vehicle As1 does not exist in the adjacent lane La1 (S214: NO), the traffic congestion recognition unit 163 determines whether the scene recommends a lane change to the adjacent lane La1 (S215). When a space surrounded by other vehicles in front and on the left and right sides exists in the adjacent lane La1, the traffic congestion recognition unit 163 determines that the above scene is a scene in which the lane change is recommended (S215: YES). In this case, the traffic congestion recognition unit 163 determines that the periphery of the subject vehicle is in the sixth traffic congestion state (see FIG. 15) (S225). On the other hand, when the space surrounded by other vehicles in front and on the left and right sides does not exist in the adjacent lane La1, the traffic congestion recognition unit 163 determines that the above scene is the scene in which the lane change is not recommended(S215: not). In this case, the traffic congestion recognition unit 163 determines that the periphery of the subject vehicle is in the fifth traffic congestion state (see FIG. 14) (S224).

Next, in the second embodiment, details of the automated driving permission process and the state control process executed by the permission controller 177 will be described.

In the automated driving permission process (see FIG. 17), the permission controller 177 refers to the lane determination result by the road grasping unit 161 and determines whether the vehicle is traveling in the passing lane Lp (S231). When the subject vehicle Ao is traveling in the traveling lane Ld (S231: NO), the permission controller 177 refers to the result of the traffic congestion recognition process executed by the traffic congestion recognition unit 163, and determines the current traffic congestion state at the periphery of the subject vehicle (S235). When the periphery of the subject vehicle is in the first traffic congestion state or the third traffic congestion state (S235: YES), the permission controller 177 permits the start of traffic congestion Level 3 automated driving (S236). On the other hand, when the periphery of the subject vehicle is in the second traffic congestion state or in a non-congestion state (S235: NO), the permission controller 177 does not permit the start of traffic congestion Level 3 automated driving (S237).

On the other hand, when the subject vehicle Ao is traveling in the passing lane Lp (S231: YES), the permission controller 177 refers to the result of the traffic congestion recognition process, and determines whether the periphery state of the subject vehicle is the sixth traffic congestion state (S232). When the periphery state of the subject vehicle is the sixth traffic congestion state (S232: YES), the permission controller 177 cooperates with the information cooperation block 60 to output a lane change proposal notification request to the HCU 100 (S233).

The HCU 100 performs the lane change proposal notification by the presentation controller 74 based on the acquisition of the execution request by the information acquisition unit 71. In the lane change proposal notification, the driver is encouraged to perform change to the traveling lane Ld. The presentation controller 74 displays the lane change presentation notification on the meter display 21 or the like. The lane change presentation notification includes an image that evokes the lane change to the traveling lane Ld (adjacent lane La1) and an image including a text message such as “The lane change enables the use of the automated driving function”, or the like. When the driver who has recognized the lane change proposal notification changes the traveling lane of the subject vehicle Ao to the traveling lane Ld, and the periphery of the subject vehicle becomes the first traffic congestion state, the permission controller 177 permits the start of the traffic congestion Level 3 automated driving (S236).

When the periphery of the subject vehicle is not in the sixth traffic congestion state (S232: NO), or when a predetermined time has elapsed in the sixth traffic congestion state, the permission controller 177 determines whether the periphery of the subject vehicle is in the fourth traffic congestion state (S234). When the periphery of the subject vehicle is in the fourth traffic congestion state (S234: YES), the permission controller 177 permits the start of traffic congestion Level 3 automated driving (S236). On the other hand, when the periphery of the subject vehicle is in the fifth traffic congestion state or in a non-congestion state (S234: NO), the permission controller 177 does not permit the start of traffic congestion Level 3 automated driving (S237)., when a situation where the periphery of the subject vehicle is in the sixth traffic congestion state continues for a predetermined time, the permission controller 177 does not permit the start of traffic congestion Level 3 automated driving.

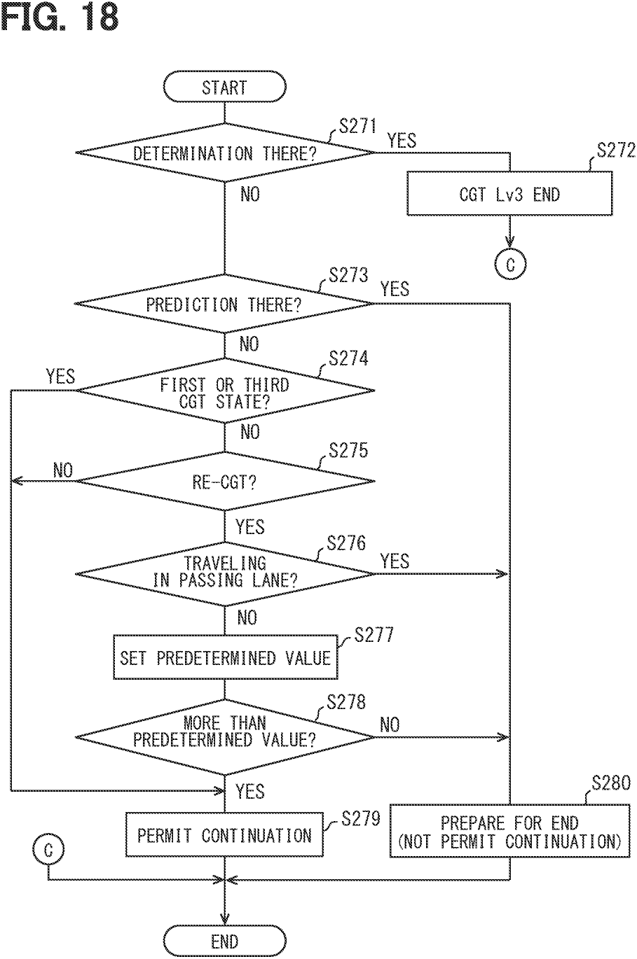

In the state control process (see FIG. 18), the permission controller 177 refers to the result of the traffic congestion resolving determination by the traffic congestion solving determination process (see FIG. 9), and determines whether there is a fixed determination that the traffic congestion has been solved (S271). When there is the fixed determination that the congestion has been solved (S271: YES), the permission controller 177 ends the autonomous traveling control at Level 3 during the traffic congestion (S272).

On the other hand, there is no fixed determination of congestion relief (S271: NO), the permission controller 177 refers to the result of the traffic congestion solving prediction (see S24 in FIG. 7) by the traffic congestion recognition unit 163 and determines whether it has been predicted that the traffic congestion is solved (S273). When there is the traffic congestion solving prediction (S273: YES), the permission controller 177 does not permit the continuation of the autonomous traveling control at Level 3 during the traffic congestion and prepares for the end of the automated driving (S280).

On the other hand, when there is no traffic congestion solving prediction (S273: NO), the permission controller 177 determines whether the traffic congestion state at the periphery of the subject vehicle is in the first traffic congestion state or the third traffic congestion state (S274). When the periphery of the subject vehicle is in the first traffic congestion state or the third traffic congestion state (S274: YES), the permission controller 177 permits the continuation of the autonomous traveling control at the level during the traffic congestion (S279). On the other hand, in a case where the periphery of the subject vehicle is in the first traffic congestion state and the third traffic congestion state (S274: NO), when all of the multiple predetermined conditions (S275, S276, S278) are satisfied, the permission controller 177 permits the continuation of the autonomous traveling control at Level 3 during the traffic congestion.

The permission controller 177 determines whether a re-traffic congestion state has occurred. The re-traffic congestion state is a state in which the vehicle speed of the subject vehicle Ao has decreased to the traffic congestion speed V2 or less after exceeding the traffic congestion speed V2 (S275). When determining that not the re-traffic congestion but the first traffic congestion has occurred (S275: NO), the permission controller 177 permits the continuation of the autonomous traveling control at the Level 3 during the traffic congestion. On the other hand, when determining that the re-traffic congestion state has occurred, the permission controller 177 determines whether the subject vehicle Ao is traveling in the passing lane Lp (S276). When the subject vehicle Ao is traveling in the passing lane Lp (S276: YES), the permission controller 177 prepares for the end of Level 3 during the traffic congestion (S280). The Level 3 during the traffic congestion may be also referred to as a traffic congestion Level 3.

When the subject vehicle Ao is traveling in the traveling lane Ld (S276: NO), the permission controller 177 determines according to the position of the host vehicle lane Lo, as in the first embodiment (see S76 in FIG. 10). A predetermined number of times as a threshold is set (S277). The permission controller 177 compares the predetermined number of times corresponding to the position of the subject vehicle lane Lo with the value of the re-traffic congestion counter 164 (S278). When the re-traffic congestion count exceeds the predetermined number of times (S278: YES), the permission controller 177 permits the continuation of the traffic congestion Level 3 (S279). On the other hand, when the count of reoccurrence of the traffic congestion is less than or equal to the predetermined number of times, in other words, a predetermined value (S278: NO), the permission controller 177 does not permit the continuation of the traffic congestion Level 3, and prepares for the end of the traffic congestion Level 3 (S280).

According to the above processes, it is possible to stop the preparation for ending the traffic congestion Level 3 started based on the prediction that the traffic congestion is going to be solved (S273: YES) based on the recognition of the re-traffic congestion state when the subject vehicle Ao travels in the traveling lane Ld (S275: YES). On the other hand, in a case where the subject vehicle Ao travels in the passing lane Lp, even when the re-traffic congestion state is recognized, the preparation for ending the traffic congestion Level 3 started based on the prediction that the traffic congestion is going to be solved continues (S276: YES, S280).

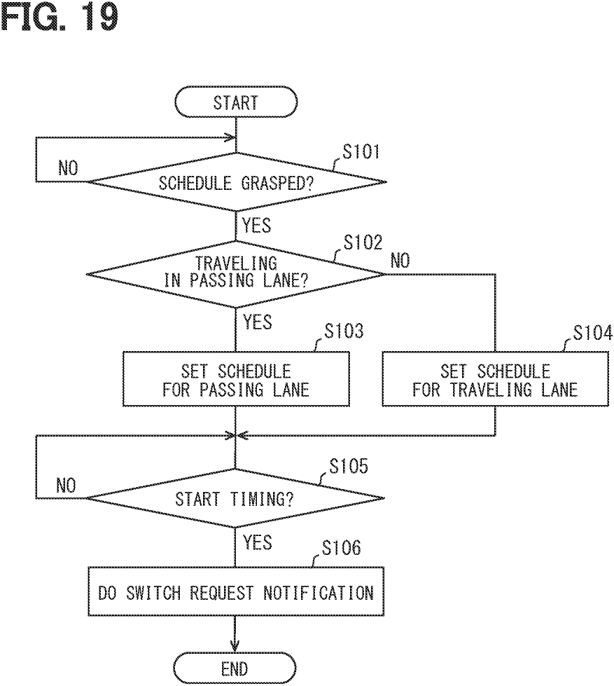

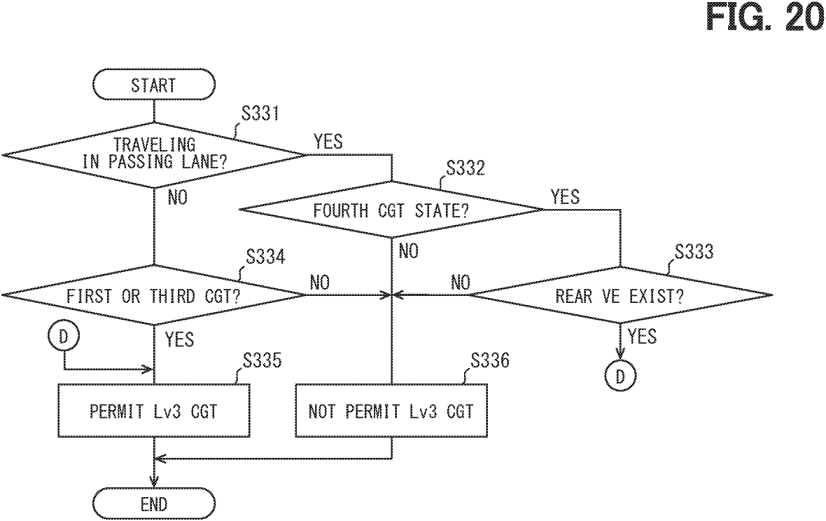

Next, the details of the driving switch request process (see FIG. 19) executed by the HCU 100 of the second embodiment will be described.

Based on the control status information provided from the automated driving ECU 50b to the information acquisition unit 71, the automated driving grasping unit 72 grasps an end schedule of the eyes-off automated driving performed only when the subject vehicle Ao travels during the traffic congestion (S101). In one example, when, in the state control process, the traffic congestion Level 3 is determined to end (see FIG. 18, S272), the control status information for providing a notification of the end schedule of the traffic congestion Level 3 is provided from the automated driving ECU 50b to the information acquisition unit 71. When the eyes-off automated driving ends, the automated driving system 50 transitions the control state of the automated driving to the level 2 driving assistance control or manual driving.

When grasping the end schedule of the traffic congestion Level 3 (S101: YES), the automated driving grasping unit 72 determines the position of the subject vehicle lane Lo. When the automated driving grasping unit 72 determines whether the subject vehicle Ao is traveling in the passing lane Lp based on the control status information including, for example, the lane determination result by the road grasping unit 161 (S102).

When the subject vehicle Ao is traveling on a road including multiple lanes, the presentation controller 74 changes a driving switch schedule according to the position of the subject vehicle lane Lo. When the subject vehicle Ao is traveling in the passing lane Lp (S102: YES), the presentation controller 74 sets a driving switch schedule for the passing lane Lp (S103). On the other hand, when the subject vehicle Ao is traveling in the traveling lane Ld (S102: NO), the presentation controller 74 sets the driving switch schedule for the traveling lane Ld (S104).

When the subject vehicle Ao is traveling in the passing lane Lp under the autonomous traveling control at the Level 3 during the traffic congestion, the presentation controller 74 sets a start timing of the switch request notification to be earlier than a start timing when the vehicle is traveling in the traveling lane Ld. Specifically, the presentation controller 74 acquires a schedule point at which the autonomous traveling control at the Level 3 during the traffic congestion is scheduled to end (hereinafter referred to as a schedule end point).The presentation controller 74 sets a point that is a predetermined distance (hereinafter referred to as driving switch distance) away from this schedule end point, as a start point of the switch request notification. The presentation controller 74 sets a longer driving switch distance in the driving switch schedule for the passing lane Lp than that in the driving switch schedule for the traveling lane Ld. In one example, when the vehicle is traveling in the passing lane Lp, the presentation controller 74 sets a point approximately 1.2 to 1.5 km away from the schedule end point, as the start point of the switch request notification. On the other hand, when the vehicle is traveling in the traveling lane Ld, the presentation controller 74 sets a point approximately 1 km away from the schedule end point, as the start point of the switch request notification.

Here, the process of adjusting the start timing of the switch request notification may be implemented in cooperation with the automated driving ECU 50b. In one example, in the case where the subject vehicle Ao is traveling in the passing lane Lp, the traffic congestion recognition unit 163 sets the traffic congestion solving speed V1 to be lower than a speed when the subject vehicle Ao is traveling in the traveling lane Ld. That is, the traffic congestion recognition unit 163 relaxes the conditions ( traffic congestion solving speed V1 or the like) for determining that the traffic congestion has been solved when the subject vehicle is traveling in the passing lane Lp. In a case where a criteria for the traffic congestion solving determination (see FIG. 18, S271) is relaxed by such the adjustment process, when the subject vehicle is traveling in the passing lane Lp, the end schedule point of the traffic congestion Level 3 is set to be closer to the subject vehicle than a point set when the subject vehicle is traveling in the traveling lane Ld. As a result, the presentation controller 74 can advance the start timing of the switch request notification.

The presentation controller 74 determines whether it is the notification start timing based on the set driving switch schedule (S105). Based on the arrival of the notification start timing (S105: YES), the presentation controller 74 starts the switch request notification and requests the driver to switch the driving. The switch request notification is a notification that indicates to the driver that the traffic congestion Level 3 is scheduled to end and that it is necessary to take over control of the driving operation. The switch request notification starts before the traffic congestion Level 3 ends and continues for a predetermined period. The presentation controller 74 causes at least one of the meter display 21 or the HUD 23 to display an image including a text message such as, for example, “automated driving is going to be canceled, please hold the steering wheel” as the switch request notification. The presentation controller 74 may change an emission color of the ambient light 25 as the switch request notification.

Also in the second embodiment described above, the condition for continuing the eyes-off automated driving is relaxed more than the condition for starting, as in the first embodiment. As the result, it is possible to easily perform continuous eyes-off automated driving. Therefore, it is possible to ensure the convenience of automated driving.

In addition, in the second embodiment, when the subject vehicle Ao travels in the passing lane Lp, the start of the eyes-off automated driving based on the recognition of the traffic congestion state is prevented. In general, the traffic congestion in the passing lane Lp tends to be solved earlier than in the traveling lane Ld. Therefore, according to the prevention of the start of the eyes-off automated driving in the passing lane Lp, it is possible to avoid quick end of the once-started eyes-off automated driving. As described above, it is possible to easily perform the continuous eyes-off automated driving. Therefore, it is possible to ensure the convenience of automated driving.

Further, according to the second embodiment, the traffic congestion recognition unit 163 recognizes, as the fourth traffic congestion state, the traffic congestion state, in which the subject vehicle Ao travels in the passing lane Lp, the vehicle speed of the subject vehicle is equal to or less than the traffic congestion speed V2, and also both of the front vehicle Af and the side vehicle As1 exist. Furthermore, the traffic congestion recognition unit 163 recognizes, as the fifth traffic congestion state, the traffic congestion state, in which the subject vehicle Ao travels in the passing lane Lp, the vehicle speed of the subject vehicle is equal to or less than the traffic congestion speed V2, the front vehicle Af exists, and the side vehicle As1 does not exist. Then, the permission controller 177 permits the start of the eyes-off automated driving when the periphery of the subject vehicle is in the fourth traffic congestion state. The permission controller 177 does not permit the start of the eyes-off automated driving when the periphery of the subject vehicle is in the fifth traffic congestion state.

In general, it is estimated that solving the fourth traffic congestion state (first traffic congestion state) in which the side vehicle As1 exists in the adjacent lane La1 is more difficult than solving the fifth traffic congestion state (second traffic congestion state) in which the side vehicle As1 does not exist in the adjacent lane La1. Therefore, even when the eyes-off automated driving is permitted in the fourth traffic congestion state, a situation where the once-started eyes-off automated driving quickly ends is unlikely to occur. As the result, while increasing the scenes used for the eyes-off automated driving, and it is possible to perform the continuous eyes-off automated driving. Therefore, it is possible to improve the convenience of the automated driving.

Furthermore, in the second embodiment, when, due to the lane change from the passing lane Lp to the traveling lane Ld, the start of the eyes-off automated driving based on the recognition of the traffic congestion state is permitted, the lane change proposal notification is performed for encouraging the driver to perform the lane change to the traveling lane Ld. Such notification makes it easier for the driver to use the eyes-off automated driving function even when the start of eyes-off automated driving in the passing lane Lp is restricted. Accordingly, it is possible to further improve the convenience of the automated driving.

In addition, in the second embodiment, in the case where the subject vehicle Ao travels in the passing lane Lp, even when the re-traffic congestion state is recognized, the preparation for ending the eyes-off automated driving continues. As described above, the traffic congestion in the passing lane Lp is likely to be solved earlier than in the traveling lane Ld. Therefore, it is possible to prevent unnecessary changes in the control state by continuing the preparation for ending the eyes-off automated driving even when the re-traffic congestion state has occurred. As the result, it is possible to smoothly end the eyes-off automated driving. Therefore, it is possible to ensure the convenience of automated driving.

In addition, in the second embodiment, when the subject vehicle is traveling in the passing lane Lp, the start timing of the switch request notification is set to be earlier than the start timing in the case of traveling in the traveling lane Ld. As described above, the traffic congestion in the passing lane Lp is likely to be solved earlier than in the traveling lane Ld. Therefore, by setting the start timing of the switch request notification in the passing lane Lp to the earlier timing, it is possible to smoothly execute the driving switch process from the eyes-off automated driving to the driver. Therefore, it is possible to ensure the convenience of automated driving.

Further, in the second embodiment, in the case of traveling in the passing lane Lp, the driving switch distance from the end schedule point of the eyes-off automated driving to the start point of the switch request notification is set to be longer than that in the case of traveling in the traveling lane Ld. According to the above, it is possible to surely advance the start timing of the change request notification, so that it is possible to more easily implement the smooth driving switch.

In addition, in the second embodiment, in the case where the subject vehicle Ao is traveling in the passing lane Lp, the condition for solving the traffic congestion is eased as compared with the condition when the subject vehicle Ao is traveling in the traveling lane Ld. Such control also makes it possible to surely advance the start timing of the switch request notification. Therefore, it becomes easier to implement the smooth driving switch.

In the second embodiment, the information cooperation block 60 corresponds to a “notification execution unit”, the automated driving grasping unit 72 corresponds to a “control grasping unit”, and the presentation controller 74 corresponds to a “notification controller”, the road grasping unit 161 corresponds to a “lane determination unit” in addition to the “road type grasping unit” described above. Further, the HCU 100 corresponds to a “presentation control device”.

### Third Embodiment

A third embodiment according to the present disclosure is a modification of the second embodiment. In the third embodiment, the details of the automated driving permission process (see FIG. 20) executed by the automated driving ECU 50b are different from those in the second embodiment. In the third embodiment, the condition (hereinafter referred to as a first permission condition) for permitting the start of the traffic congestion Level 3 in the case of traveling in the passing lane Lp is set to be stricter than that (hereinafter referred to as a second permission condition) in the case of traveling in the traveling lane Ld. Hereinafter, details of the automated driving permission process according to the third embodiment will be described based on FIG. 20 with reference to FIGS. 1, 3 to 6, and 13 to 15.

When the subject vehicle Ao is traveling in the traveling lane Ld (S331: NO) and the periphery of the subject vehicle is in the first traffic congestion state or the third traffic congestion state (S334: YES), the permission controller 177 permits the start of the traffic congestion Level 3 (S335). That is, the second permission condition is that the vehicle speed of the subject vehicle Ao is equal to or lower than the traffic congestion speed V2, and that all of the front vehicle Af and the side vehicles As1 and As2 exits.

On the other hand, when the subject vehicle Ao is traveling in the passing lane Lp (S331: YES) and the periphery of the subject vehicle is in the fourth traffic congestion state (S332: YES), the permission controller 177 refers to the grasping result of the different vehicle by the different vehicle grasping unit 162. The permission controller 177 further determines whether the rear vehicle exists based on the grasping result of the different vehicle (S333). The rear vehicle is a different vehicle that travels in the subject vehicle lane Lo, is positioned behind the subject vehicle Ao, and is traveling so as to follow the subject vehicle Ao. When the rear vehicle is recognized (S333: YES), the permission controller 177 permits the start of the traffic congestion Level 3 (S335). On the other hand, when the rear vehicle is not recognized (S333: NO), the permission controller 177 does not permit the start of the traffic congestion Level 3 (S336). As described above, the first permission condition is that the vehicle speed of the subject vehicle Ao is equal to or lower than the traffic congestion speed V2, and that all of the front vehicle Af, the side vehicle As1, and the rear vehicle exits.

Also in the third embodiment described above, the first permission condition in the case where the subject vehicle Ao travels in the passing lane Lp is set stricter than the second permission condition in the case where the vehicle Ao travels in the traveling lane Ld. As a result, the start of eyes-off automated driving in the passing lane Lp is prevented. As described above, the traffic congestion in the passing lane Lp tends to be solved earlier than in the traveling lane Ld. Therefore, according to the prevention of the start of the eyes-off automated driving in the passing lane Lp, it is possible to avoid quick end of the once-started eyes-off automated driving. As described above, also the third embodiment provides the similar effects to that of the second embodiment. It is possible to easily perform continuous eyes-off automated driving. Therefore, it is possible to ensure the convenience of automated driving.

In addition, among the first permission condition and the second permission condition, only the first permission condition is set, by the permission controller 177 of the third embodiment, so as to include the condition that the rear vehicle has been grasped by the different vehicle grasping unit 162. In this way, it is estimated that when the rear vehicle exists, the traffic congestion state is more difficult to be solved than that in a state where the rear vehicle does not exist. Therefore, when the eyes-off automated driving is permitted on the condition that the rear vehicle exists, the situation where the once-started eyes-off automated driving quickly ends is unlikely to occur. According to the above, it is possible to perform the continuous eyes-off automated driving. Therefore, it is possible to more improve the convenience of the automated driving.

### Other Embodiments

Although multiple embodiments of the present disclosure have been described above, the present disclosure is not construed as being limited to the above-described embodiments, and can be applied to various embodiments and combinations within a range that does not depart from the spirit of the present disclosure.

In the above-described first embodiment, when all the conditions such as the elapsed time of the eyes-off automated driving, the driver driving posture, the road type, and the content of the second task are satisfied, the continuation of the automated driving in the second traffic congestion state is permitted. On the other hand, in a first modification of the first embodiment described above, at least part of the above conditions are omitted. In one example, according to the first modification, in the second traffic congestion state, the continuation of the automated driving is permitted in the similar manner to that in the first and third traffic congestion states, even when the above other conditions are not satisfied.

In a second modification of the first embodiment described above, the predetermined number of adjustments are omitted according to the number of adjacent lanes La1 and La2. Further, in a third modification of the first embodiment described above, counting the number of times of re-traffic congestion by the re-traffic congestion counter 164 is omitted.

In a fourth modification of the first embodiment described above, the process for canceling and suspending the eyes-off automated driving based on the traffic congestion information is omitted. Further, in a fifth modification of the first embodiment described above, the process for canceling and suspending the eyes-off automated driving based on the driver traffic congestion continuation determination is omitted.

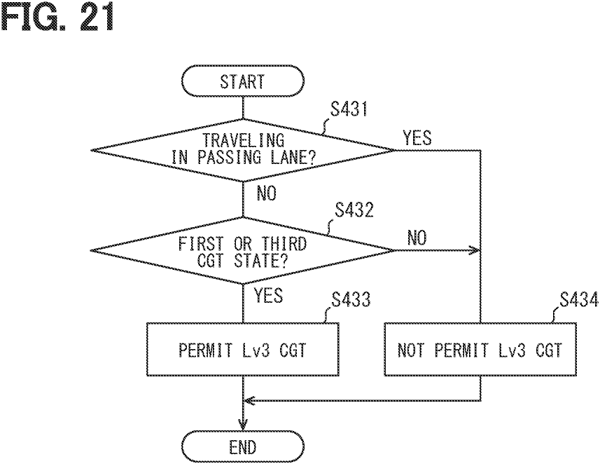

In the automated driving permission process (see FIG. 21) of a sixth modification of the second embodiment, the determination of whether the fourth traffic congestion state is present is omitted. When the subject vehicle Ao is traveling in the passing lane Lp (S431: YES), the permission controller 177 does not permit the start of the eyes-off automated driving (S434). Also in the sixth modification, when the subject vehicle Ao is traveling in the traveling lane Ld (S431: NO) and the periphery of the subject vehicle is in the first traffic congestion state or the third traffic congestion state (S432: YES), the permission controller 177 permits the start of the traffic congestion Level 3 (S433).

Each function of the driving assistance ECU 50a and the automated driving ECU 50b of the above embodiments may be provided by one automated driving ECU. In addition, the automated driving ECU may have the functions of the HCU. Thus, in the form in which the functions of the HCU are implemented in the automated driving ECU, the integrated ECU (computer) corresponds to an “automated driving control device” and an “information presentation device”. Furthermore, the presentation controller 74 corresponds to a “notification execution unit”.

Further, in the above embodiments and modifications, the respective functions provided by the automated driving ECU and the HCU can be also provided by software and hardware for executing the software, only software, only hardware, and complex combinations of software and hardware. Further, in a case where these functions are provided by electronic circuits as hardware, the functions can be also provided by analog circuits or digital circuits which include a large number of logic circuits.

Each of the processing units of the above-described embodiments may be individually mounted on a printed circuit board, or may be mounted on an ASIC (Application Specific Integrated Circuit), a FPGA, or the like. The storage medium (non-transitory tangible computer-readable storage medium or non-transitory tangible storage medium) that stores the program for implementing the automated driving control method and the presentation control method may be changed as appropriate. For example, the storage medium is not limited to the configuration provided on the circuit board, and may be provided in the form of a memory card or the like. The storage medium may be inserted into a slot portion, and electrically connected to the control circuit of the HCU. The storage medium may include an optical disk which forms a source of programs to be copied into a HCU, a hard disk drive therefor, and the like.

The vehicle equipped with the HMI system is not limited to a general private car, but may be a rented vehicle, a vehicle for man-driving taxi, a vehicle for sharing vehicle service, a freight vehicle, a bus, or the like. A HMI system including the HCU may be mounted on a vehicle dedicated to unmanned driving used for mobility services.

The vehicle equipped with the HMI system may be a right-hand drive vehicle or a left-hand drive vehicle. Further, the traffic environment in which the vehicle travels may be a traffic environment premised on left-hand traffic, or may be a traffic environment premised on right-hand traffic. According to the present disclosure, the display of each content for the driving assistance is appropriately optimized according to the road traffic law of each country and region, the steering wheel position of the vehicle, and the like.

The controllers and methods thereof described in the present disclosure may be implemented by a special purpose computer which includes a processor programmed to execute one or more functions implemented by computer programs. Alternatively, the device and method described in the present disclosure may be implemented by a special purpose hardware logic circuit. Alternatively, the device and the method described in the present disclosure may be implemented by one or more special purpose computers configured by a combination of a processor executing a computer program and one or more hardware logic circuits. The computer program may be stored in a computer readable non-transitory tangible storage medium as computer-executable instructions.

Here, the process of the flowchart or the flowchart described in this application includes a plurality of sections (or steps), and each section is expressed as, for example, S11. Further, each section may be divided into several subsections, while several sections may be combined into one section. Furthermore, each section thus configured may be referred to as a device, module, or means.

1. An automated driving control device capable of performing eyes-off automated driving without periphery monitoring obligation by a driver, the device comprising:
a different vehicle grasping unit configured to grasp at least
existence of a front vehicle in a subject vehicle lane in which a subject vehicle is positioned and
existence of a side vehicle that is adjacent to the subject vehicle and is positioned in an adjacent lane adjacent to the subject vehicle lane;
a traffic congestion recognition unit configured to recognize
a first traffic congestion state in which a vehicle speed of the subject vehicle is equal to or less than a predetermined speed and all of the front vehicle in the subject vehicle lane and the side vehicle in the adjacent lane exist and
a second traffic congestion state in which the vehicle speed of the subject vehicle is equal to or less than the predetermined speed, the front vehicle exists in the subject vehicle lane, and the side vehicle does not exist in the adjacent lane; and
a permission controller that
is configured to permit a start of the eyes-off automated driving in the first traffic congestion state
is configured not to permit the start of the eyes-off automated driving in the second traffic congestion state, wherein
the permission controller permits continuation of the eyes-off automated driving when a periphery of the subject vehicle transitions to the second traffic congestion state after the eyes-off automated driving starts in the first traffic congestion state.

2. The automated driving control device according to claim 1, further comprising
a time measurement unit configured to measure an elapsed time from the start of the eyes-off automated driving, wherein
the permission controller
permits the continuation of the eyes-off automated driving in the second traffic congestion state when the elapsed time is within a predetermined time, and
does not permit the continuation of the eyes-off automated driving in the second traffic congestion state when the elapsed time exceeds the predetermined time.

3. The automated driving control device according to claim 1, further comprising
a posture grasping unit configured to grasp a driving posture of the driver, wherein
the permission controller is configured to determine the continuation of the eyes-off automated driving in the second traffic congestion state according to the driving posture of the driver.

4. The automated driving control device according to claim 1, further comprising
a road type grasping unit configured to grasp a road type of a road on which the subject vehicle is traveling, wherein
the permission controller is configured to determine the continuation of the eyes-off automated driving in the second traffic congestion state according to the road type.

5. The automated driving control device according to claim 1, further comprising
a task grasping unit configured to grasp a content of a task other than driving performed by the driver during the eyes-off automated driving, wherein
the permission controller is configured to determine the continuation of the eyes-off automated driving in the second traffic congestion state according to the content of the task.

6. The automated driving control device according to claim 1, wherein
the traffic congestion recognition unit includes a re-traffic congestion counter configured to
predict that a traffic congestion is solved, and
count reoccurrence of the traffic congestion after predicting that the traffic congestion is solved, and
the permission controller
does not permit the continuation of the eyes-off automated driving in the second traffic congestion state during the reoccurrence of the traffic congestion when a count of the reoccurrence of the traffic congestion is equal to or less than a predetermined value, and
permits the continuation of the eyes-off automated driving in the second traffic congestion state during the reoccurrence of the traffic congestion when the count of the reoccurrence of the traffic congestion exceeds the predetermined value.

7. The automated driving control device according to claim 6, wherein
in a case where the adjacent lane exists only on one side of the subject vehicle lane, the permission controller sets the predetermined value to be lower than a value in a case where the adjacent lane exists on both sides of the subject vehicle lane.

8. An automated driving control device capable of performing eyes-off automated driving without periphery monitoring obligation by a driver, the device comprising:
a lane determination unit configured to determine whether a subject vehicle is traveling in a passing lane;
a traffic congestion recognition unit configured to recognize a traffic congestion state at a periphery of the subject vehicle;
a permission controller that
is configured to permit a start of the eyes-off automated driving based on a recognition of the traffic congestion state when the subject vehicle travels in a traveling lane different from the passing lane and
is configured not to permit the start of the eyes-off automated driving when the subject vehicle travels in the passing lane; and
a different vehicle grasping unit configured to grasp at least existence of a front vehicle in a subject vehicle lane in which a subject vehicle is positioned and existence of a side vehicle that is adjacent to the subject vehicle and is positioned in an adjacent lane adjacent to the subject vehicle lane, wherein
when the subject vehicle travels in the passing lane, the traffic congestion recognition unit recognizes
a first traffic congestion state in which a vehicle speed of the subject vehicle is equal to or less than a predetermined speed and both of the front vehicle and the side vehicle exist and
a second traffic congestion state in which the vehicle speed of the subject vehicle is equal to or less than the predetermined speed, the front vehicle exists in the subject vehicle lane, and the side vehicle does not exist, and
the permission controller
permits a start of the eyes-off automated driving when the subject vehicle is traveling in the passing lane and the traffic congestion recognition unit has recognized the first traffic congestion state, and
does not permit the start of the eyes-off automated driving when the subject vehicle is traveling in the passing lane and the traffic congestion recognition unit has recognized the second traffic congestion state.

9. The automated driving control device according to claim 8, further comprising
a notification execution unit configured to perform a notification for encouraging the driver to perform lane change to the traveling lane when the permission controller permits the start of the eyes-off automated driving based on the recognition of the traffic congestion state due to a lane change from the passing lane to the traveling lane.

10. An automated driving control device capable of performing eyes-off automated driving without periphery monitoring obligation by a driver, the device comprising:
a lane determination unit configured to determine whether a subject vehicle is traveling in a passing lane;
a traffic congestion recognition unit configured to recognize a traffic congestion state unit at a periphery of the subject vehicle;
a permission controller configured to set a first permission condition to be stricter than a second permission condition, wherein the first permission condition is a condition that permits a start of the eyes-off automated driving based on the traffic congestion state when the subject vehicle travels in the passing lane, and the second permission condition is a condition that permits the eyes-off automated driving based on the traffic congestion state when the subject vehicle travels in a traveling lane different from the passing lane; and
a different vehicle grasping unit configured to grasp existence of a different vehicle at the periphery of the subject vehicle, wherein
the permission controller is configured to set the first permission condition to a condition including a state where a rear vehicle, which is the different vehicle, has been recognized among the first permission condition and the second permission condition.

11. An automated driving control device capable of performing eyes-off automated driving without periphery monitoring obligation by a driver, the device comprising:
a lane determination unit configured to determine whether a subject vehicle is traveling in a passing lane;
a traffic congestion recognition unit configured to recognize a traffic congestion state at a periphery of the subject vehicle; and
a permission controller configured to
permit a start of the eyes-off automated driving based on recognition of the traffic congestion state, and
start preparation for ending the eyes-off automated driving when a vehicle speed of the subject vehicle exceeds a predetermined speed after a start of the eyes-off automated driving, wherein
the traffic congestion recognition unit recognizes that the traffic congestion state has occurred again when the predetermined speed becomes equal to or less than the predetermined speed again after the vehicle speed of the subject vehicle exceeds the predetermined speed, and
the permission controller
stops the preparation for ending the eyes-off automated driving based on recognition that the traffic congestion state has occurred again, when the subject vehicle travels in a traveling lane different from the passing lane, and
continues the preparation for ending the eyes-off automated driving even when having recognized that the traffic congestion state has occurred again, in a case where the subject vehicle travels in the passing lane.

12. An automated driving control device capable of, by using information of an autonomous sensor, performing eyes-off automated driving without periphery monitoring obligation by a driver, the device comprising:
a traffic congestion information acquisition unit configured to acquire traffic congestion information of a road on which a subject vehicle is scheduled to travel;
a traffic congestion recognition unit configured to recognize whether a periphery of the subject vehicle is in a traffic congestion state by using the information of the autonomous sensor; and
a permission controller configured to permit a start of the eyes-off automated driving when the traffic congestion recognition unit has recognized that the periphery of the subject vehicle is in the traffic congestion state, wherein
the permission controller suspends an end of the eyes-off automated driving when determining that the traffic congestion state continues based on the traffic congestion information, in a case of having recognized that a traffic congestion is solved after a start of the eyes-off automated driving.

13. An automated driving control device capable of, by using information of an autonomous sensor, performing eyes-off automated driving without periphery monitoring obligation by a driver, the device comprising:
a traffic congestion information acquisition unit configured to acquire input information of the driver, the input information indicating whether a road on which a subject vehicle is scheduled to travel is congested;
a traffic congestion recognition unit configured to recognize whether a periphery of the subject vehicle is in a traffic congestion state by using the information of the autonomous sensor; and
a permission controller configured to permit a start of the eyes-off automated driving when the traffic congestion recognition unit has recognized that the periphery of the subject vehicle is in the traffic congestion state, wherein
the permission controller suspends an end of the eyes-off automated driving when the traffic congestion information acquisition unit has acquired the input information indicating continuation of a traffic congestion, in a case of having recognized that the traffic congestion is solved after a start of the eyes-off automated driving.
